(19) United States
(12) Patent Application Publication
(10) Pub. No.: US 2026/0037992 A1
(43) Pub. Date: Feb. 5, 2026

(54) ENHANCED CONTENT MANAGEMENT AND REPOSTING METHODS AND SYSTEMS FOR SOCIAL MEDIA AND SEARCH PLATFORMS

(71) Applicant: Adeia Guides Inc., San Jose, CA (US)

(72) Inventors: Charles Dasher, Lawrenceville, GA (US); Reda Harb, Tampa, FL (US)

(21) Appl. No.: 18/790,161

(22) Filed: Jul. 31, 2024

(51) Int. Cl. G06Q 30/0201; G06Q 50/00

(52) U.S. Cl. CPC G06Q 30/0201; G06Q 50/01

(57) ABSTRACT

Systems and methods are described for determining type of user engagement with a post on a social media platform and using engagement related metrics to determine configurations to be performed on a distinct application (e.g., an over-the-top {OTT}, search, map/navigation, or marketplace application). The methods include transmitting data related to user engagement with a post on a social media platform to the distinct application to take an action on the user's account associated with the distinct application. The action may be to configure a wallpaper or screen server, recommend media assets, or rank search results on the distinct application based on the user engagement with the social media post. The methods also include analyzing user consumption data on an OTT application to retrieve personalized content corresponding to the consumption and posting it in the user's feed on a social media platform.

### FIELD OF DISCLOSURE

Embodiments of the present disclosure relate to a social media server transmitting data related to user engagement with a post on a social media platform to an over-the-top (OTT) server for analysis and using results of the analysis for providing media content recommendations, configuring OTT application screensavers and wallpapers, and taking other actions on the OTT application based on the user engagement data received from the social media server. Embodiments of the present disclosure also relate to using OTT application consumption data to recommend media (e.g., clips, scenes, or images) on a social media site.

### BACKGROUND

Social media platforms have revolutionized the way individuals and communities communicate, share information, and interact online. These platforms allow users, including companies, to post a variety of content, including text, images, advertising, and videos, that other users can interact with through “likes,” shares, comments, and reposts. As users navigate through vast amounts of content, they engage with posts that resonate with their interests or provoke interaction.

Although social media platforms are great for communications and catching up with news or friends, the activity performed by a user on social media, the user's interests in a topic while navigating through their social media feed, or their likes and dislikes are not utilized outside the social media platform.

Another significant challenge with social media is the efficient management of content provided on the social media platform by a user. For example, if a user finds meaningful content during a current or previous session on social media, and the user wishes to save, repost, or reflect on specific content, they must individually select each item for reposting or saving, which can be time-consuming and disruptive, especially when dealing with large volumes of content. Additionally, the social media platforms typically do not provide tools that allow users to easily revisit or reflect on their interactions with content over time. While some platforms offer basic bookmarking or “like” features to track user preferences, these tools do not capture the depth of interaction or provide a curated experience based on the user's engagement history. Moreover, the problem extends to the difficulty of sharing multiple pieces of content efficiently. Users looking to repost several items must individually process each post, navigating away from their current feed, which disrupts the flow of their social media experience. This often results in a loss of context and continuity, which can diminish the overall engagement and enjoyment of the platform.

Yet another drawback with current social media technologies is their lack of interaction with OTT service providers, such as Netflix or Amazon. Due to the lack on interaction, user's interests while using the social media platform are not leveraged by OTT service providers (or vice versa) which prevents them from catering to the user's interests on another platform, such as the OTT platform or the social media platform.

Lack of interaction between the social media platform and the OTT service provider also results in postings made by the OTT service provider on their social media page being skipped by the user due to the user assuming lack of interest in the posting when in fact the posting may be related to content that would be of interest to the user. As such, both the OTT service provider and the user may not benefit when media asset postings are skipped and do not effectively engage the user due to a false presumption that the media asset does not contain content that would be of the user's interest.

As such, there is a need for systems and methods for utilizing user interactions with posts outside social media in an external application, such as an OTT application setting. There is also a need for systems and methods for OTT service providers to present effective content on social media that would engage a user. There is also a need for systems and methods for providing better management and revisiting of user interactions on social media.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale. Various objects and advantages of the disclosure will be apparent upon consideration of the following detailed description, taken in conjunction with the accompanying drawings, in which like reference characters refer to like parts throughout, and in which:

FIG. 1A is a block diagram of a process for selecting images and clips from a media asset based on a user's consumption history of media assets on an OTT application and posting them on a social media platform for the user's consumption, in accordance with some embodiments of the disclosure;

FIG. 1B is a block diagram of a process for activating a wallpaper or screen saver or recommending a media asset on an OTT application for the user's account based on the user's engagement with a social media post on a social media platform, in accordance with some embodiments of the disclosure.

FIG. 1C is a block diagram of a process for enhancing search results based on the user's engagement with a social media post, in accordance with some embodiments of the disclosure.

FIG. 2 is a block diagram of an example system that can be used for performing the disclosed embodiments, in accordance with some embodiments of the disclosure;

FIG. 3 is a block diagram of an electronic device used for performing the disclosed embodiments, in accordance with some embodiments of the disclosure;

FIG. 4 is a flowchart of a process for selecting images and clips from a media asset based on a user's consumption history of media assets on an OTT application and posting them on a social media platform for the user's consumption, in accordance with some embodiments of the disclosure;

FIG. 5 is a flowchart of a process for displaying customized content on a social media application based on a user's preferences determined from user consumption history on an OTT application, in accordance with some embodiments of the disclosure;

FIG. 6 is a block diagram of an example of using a user's consumption history from an OTT application to select and post images and clips on a social media application, in accordance with some embodiments of the disclosure;

FIG. 7 is a flowchart of a process for configuring an OTT application for a user based on the user's engagement with a post on a social media application, in accordance with some embodiments of the disclosure;

FIG. 8 is a block diagram of an example of activating a wallpaper or screen saver on an OTT application based on user engagement with a post on a social media application, in accordance with some embodiments of the disclosure;

FIG. 9 is a block diagram of an example of recommending a media asset on an OTT application based on user engagement with a post on a social media application, in accordance with some embodiments of the disclosure;

FIG. 10 is an example of recommending multiple media assets on an OTT application's use interface based on user engagement with a post on a social media application, in accordance with some embodiments of the disclosure;

FIG. 11 is a flowchart of a process for enhancing search results for a query entered into a search engine based on user engagement with a post on a social media application, in accordance with some embodiments of the disclosure;

FIG. 12 is a flowchart of a process for enhancing search results for a query entered into a search engine based on user engagement with a post on a social media application, in accordance with some embodiments of the disclosure;

FIG. 13 is a block diagram of an example of providing enhanced search results based on user engagement with a post on a social media application, in accordance with some embodiments of the disclosure;

FIG. 14 is an example of a communication process between a social media server and an OTT service provider server, in accordance with some embodiments of the disclosure;

FIG. 15 is a block diagram of a plurality of engagement measuring factors used in determining the user's engagement with a social media post, in accordance with some embodiments of the disclosure;

FIG. 16 is a block diagram of a social media posting features provided by the methods and systems disclosed, in accordance with some embodiments of the disclosure;

FIG. 17 is a flowchart of a process for summarizing posts and providing them for reposting using a one-click feature, in accordance with some embodiments of the disclosure;

FIG. 18 is a flowchart of a process for generating curated lists or posts that can be reposted, in accordance with some embodiments of the disclosure;

FIG. 19 is a flowchart of a process for generating summaries of posts that may be used for reposting, in accordance with some embodiments of the disclosure;

FIG. 20 is a flowchart of a process for cross-posting posts on multiple platforms, in accordance with some embodiments of the disclosure; and

FIG. 21 is an example of a post being cross-posted on multiple social media platforms, in accordance with some embodiments of the disclosure.

### DETAILED DESCRIPTION

In accordance with some embodiments disclosed herein, some of the above-mentioned limitations are overcome by monitoring user consumption history on a first application, such as an OTT application, analyzing the monitored user consumption to determine user preferences, and based on the monitoring and analysis, selecting an image, scene, or video that is aligned with the determined user preferences, and posting the selected image, scene, or portion of a video content item (e.g., movie) on a second application, e.g., a social media application, that is distinct from the first application, such that when a user interacts with the post related to the video, the user would see a personalized image, scene, or clip related to the video

Some of the above-mentioned limitations are also overcome by monitoring user interaction with a post on social media and determining whether the interaction is a positive or negative interaction or over a threshold score. Based on the type of interaction, i.e., positive, or negative, performing an action on a different application, e.g., an OTT application that is distinct from the social media application on which the interaction with the post took place. In one embodiment, in response to a positive interaction or engagement with the post on the social media application by the user, configuring a screen saver or a wallpaper on the OTT application for the user's account such that when the user logs in using their account to the OTT application, a screen saver or a wallpaper having the same image, scene, or video clip as the post with which the user engaged positively in the social media application is displayed on the OTT application. In another embodiment, in response to a positive interaction or engagement with the post on the social media application by the user, configuring one or more media asset recommendations that are related to the post on the OTT application for the user's account such that when the user logs in using their account to the OTT application, the recommendations of media assets that are related to the post with which the user engaged positively in the social media application are displayed on the OTT application. In yet another embodiment, in response to a positive interaction or engagement with the post on the social media application by the user, the operating system (OS) of the user device may be updated. In this embodiment, an update option may be presented to the user when the user interacts with a post that relates to a software bug that may be in a product. For example, the post may indicate that there is a new update for watching movies on Netflix or a detected issue with Apple TV may be fixed with a new software release. If the user approves the option, the update may to the device OS may be automatically performed.

Some of the above-mentioned limitations are also overcome by monitoring user interaction with a post on social media and determining whether the interaction is a positive or negative interaction or exceeds a predetermined threshold score, which may be computed based on the degree of engagement, e.g., degree of positive or negative engagement. Based on the type of interaction, i.e., positive, or negative, enhancing search results for a search query entered in a search engine (such as Google, Yahoo, Bing, etc.) by integrating social media insights. For example, when a search query is entered, if a topic of the search query matches a social media post with which the user may have interacted, then integrating social media insights into external application search results, such as mapping or review platforms, to enhance the relevance and personalization of search results by including posts from social media users.

Some of the above-mentioned limitations are also overcome by facilitating reposting of posts that a user has interacted with on the social media application via their social media account. Such facilitating includes providing a one-click reposting feature along with an automated tracking system that compiles and summarizes user interactions with a plurality of posts to generate dynamic content summaries that capture the nature and depth of the user interaction. The dynamic content summaries are personalized and curated and made available for easy reposting using the single button click feature. These summaries may also be presented as memories or highlights, providing users with a look back at content that resonated well with them. This feature not only personalizes the user experience but also encourages re-engagement with content. User are also provided options to mark posts they have interacted with to be included in the curated lists that may be used by them for subsequent reposting.

Some of the above-mentioned limitations are also overcome by providing a cross-platform reposting feature that allows users to share selected content from one social media platform to another. This feature is enhanced by the system's ability to categorize posts automatically based on their content type such as political, inspirational, or work-related-before they are presented for reposting. This categorization helps ensure that the content shared is appropriate and tailored to the norms and audience of the target platform. The system utilizes natural language processing and image recognition technologies to analyze the content of each post and classify it accordingly. For example, posts containing specific keywords or hashtags related to politics might be categorized as “Political,” while those featuring motivational quotes or uplifting images could be classified as “Inspirational,” and those containing family pictures or friends pictures may be categorized as “Social” or “recreational.” Different platforms may be automatically selected (or suggested for selection) based on the categorization. For example, a professional related post may be recommended to be posted on LinkedIn while a social or recreational post may be recommended to be posted on Facebook or Instagram. The embodiments may also automatically repost to such platforms if the user pre-authorizes such automatic reposting.

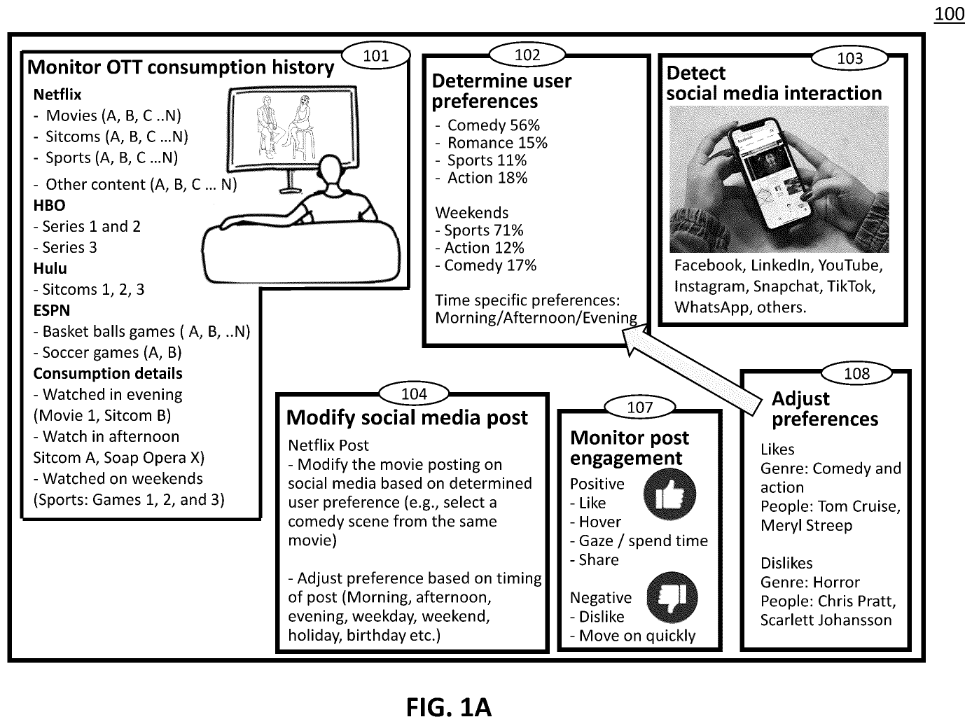

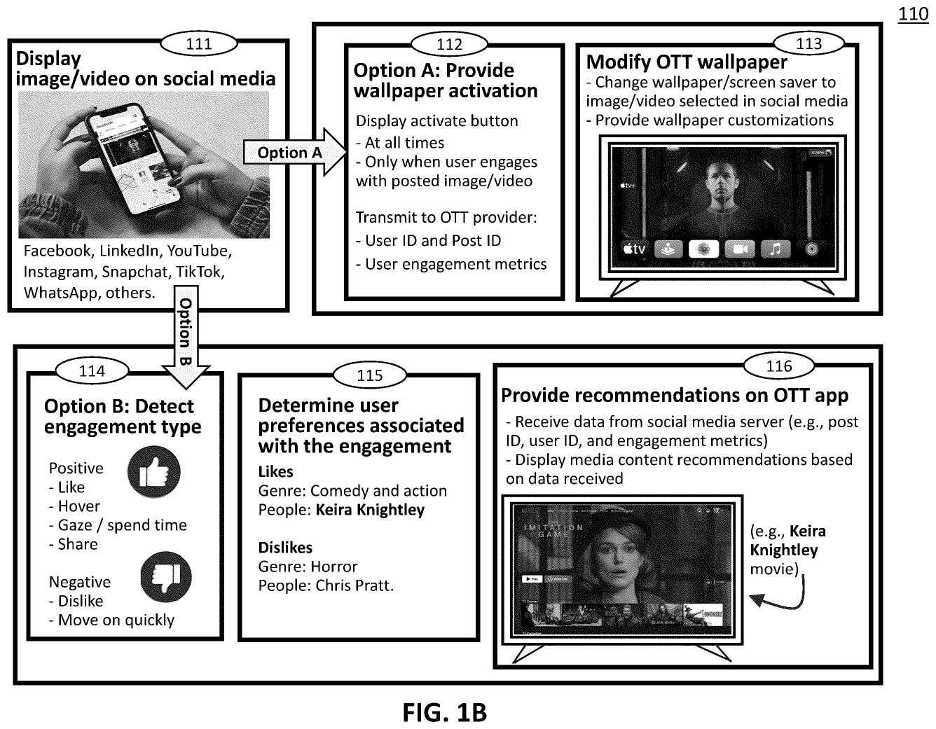

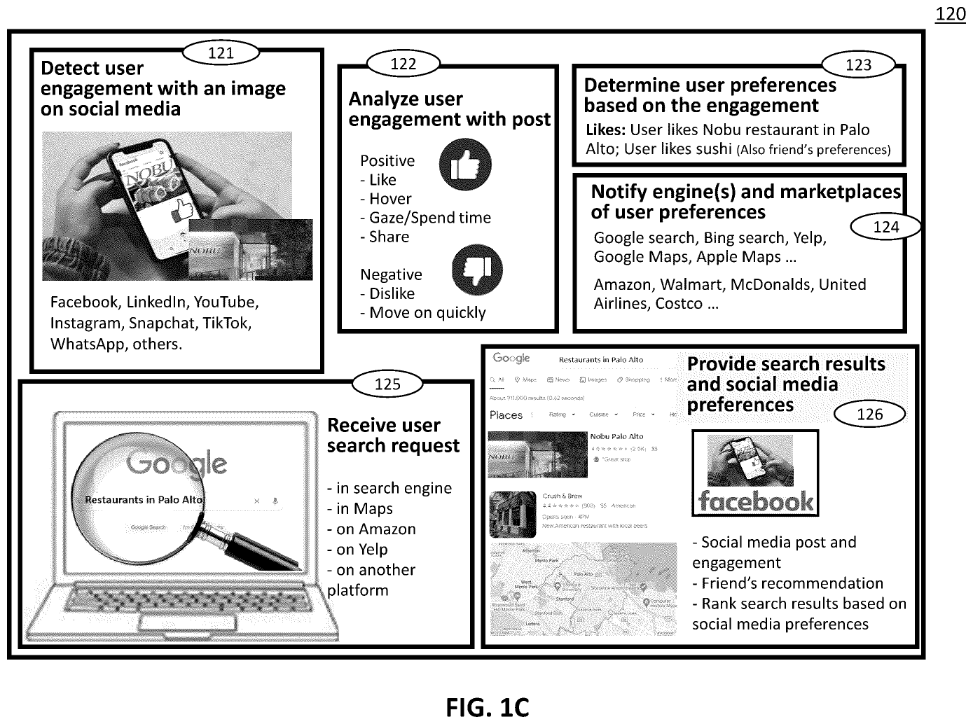

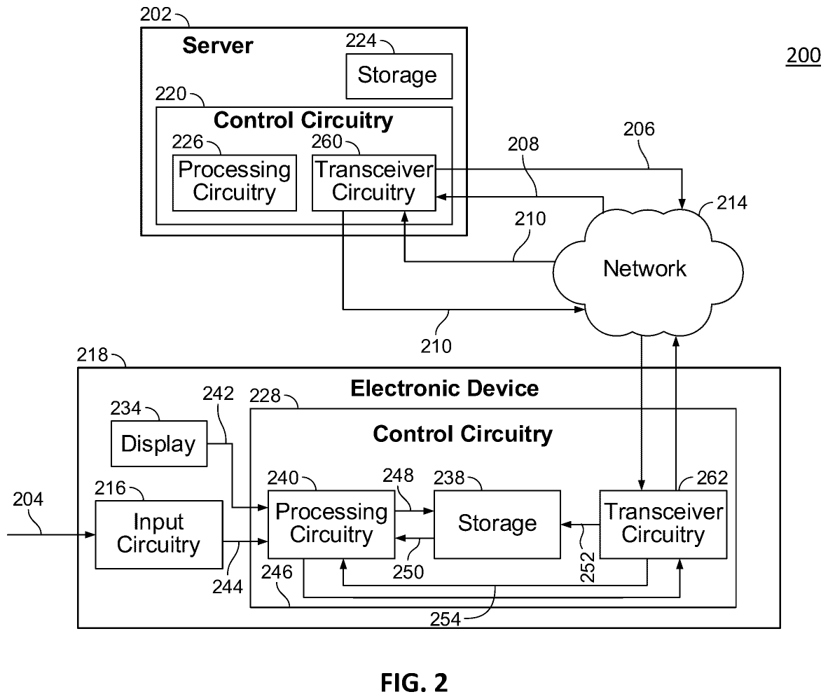

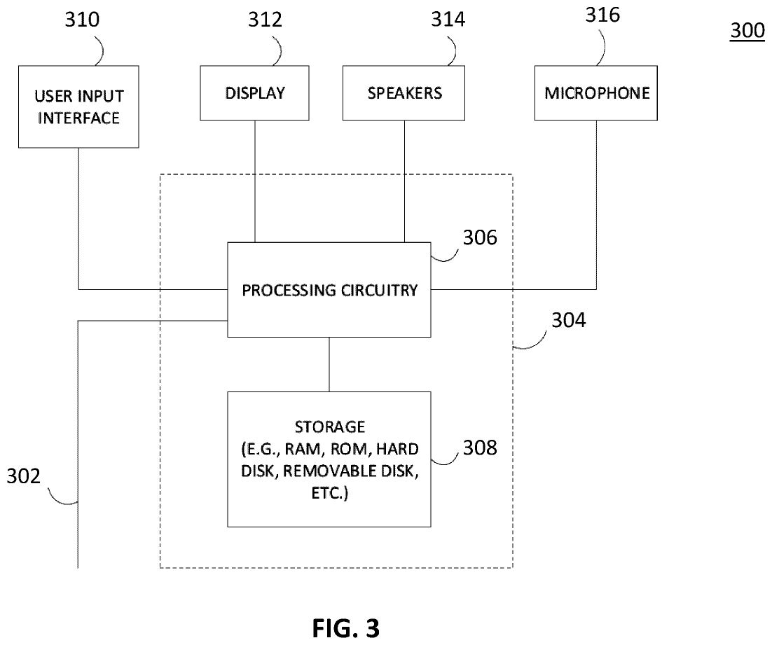

Referring to the figures, FIG. 1A is a block diagram of a process 100 for selecting images, scenes, and clips from a media asset based on a user's consumption history of media assets on an OTT application and posting them on a social media platform for the user's consumption, in accordance with some embodiments of the disclosure. The process 100 may be implemented, in whole or in part, by systems or devices such as those shown in FIGS. 2-3. One or more actions of the process 100 may be incorporated into or combined with one or more actions of any other process or embodiments described herein. The process 100 may be saved to a memory or storage (e.g., any one of those depicted in FIGS. 2-3) as one or more instructions or routines that may be executed by a corresponding device or system to implement the process 100.

Process 100 may allow an OTT service, such as Netflix, Hulu, Disney, Amazon, Apple, ESPN, and others to post ads, trailers, teasers, special offers, and images on a social media platform for a media asset provided by the OTT service. The process may involve the OTT service determining the user's interests, via the user's consumption history on the OTT application, and selecting images, scenes, and clips from the media asset that are related to the user's determined interests, such as by the OTT service provider retrieving content (such as images or scenes) corresponding to the user's interests and posting the retrieved content in the user's feed on the social media application. The determining of user's interest or preferences from user's OTT consumption history may be performed, in one embodiment, by automatically detecting patterns of user's consumption, such as media assets that have a higher content of one genre (e.g., comedy) than another genre (e.g., romance). By playing into the user's interests, the OTT service may increase the likelihood of the user engaging with the ads, trailers, scenes, and images posted on the social media platform.

In some embodiments, the process may begin at block 101, where the OTT service may monitor the user's consumption of media assets on their OTT platform. For example, Netflix may monitor consumption of media assets by a user, such as John, using the Netflix application.

In some embodiments, John may have a user account with the OTT service provider, such as Netflix. Since John may use his OTT account to consume media assets using the OTT application (such as John's Netflix account and the Netflix application), the OTT service provider may already have John's media asset consumption data. The OTT service provider may analyze John's media asset data to determine consumption patterns, likes, dislikes; preferred genres; consumption of media assets related to different genres consumed at different times of the day, week, month and on special occasions and holidays; actors, directors, producers liked and disliked by John; John's fast-forwarding and rewind patterns and what content was fast-forwarded or rewinded; episodes and series consumed; how much time John spends on average or on specific days of week or month, etc. Having John's consumption data at hand, i.e., stored in a database accessible by the OTT service provider, the OTT service provider may perform any other type of analysis desired to determine John's user preferences. Some examples of such data analysis may include determining that John likes to watch sports on weekend mornings or that on Thursday and Friday evenings John likes to consume action movies. Within the embodiments, use of the words “like,” “likes,” “liking,” etc., (and “dislike” and its variations) refers to a user action of clicking on an icon such as a thumbs-up (or thumbs-down) to indicate liking (or disliking) a post, image, clip, comment, etc.

In some embodiments, the OTT service provider, based on the media consumption data for media assets consumed on its OTT application via a user account may determine a plurality of user preferences as depicted in block 102 of FIG. 1. For example, as depicted in block 102, the user preferences determined may indicate that John consumes comedy shows 56% of the time, romance-related media assets 15% of the time, sports 11% of the time, and action 18% of the time. The OTT service provider may also determine that John watches sports 71% of the time, action 12% of the time, and comedy 17% of the time on weekends. The OTT service provider may determine different categories with which to associate John's consumption data and store such categories, including granular subcategories and user preferences related to the categories and subcategories in a database, e.g., between hours of 6:00-9:00 p.m. on weekdays, John consumes action 37% of the time and likes movies in which Tom Cruise is a lead actor; however, John fast-forwards car chase scene 87% of the time.

At block 103, a detection may be made that the user, such as John, is interacting with their social media account, which is associated with a social media application. Some examples of social media applications include Facebook, LinkedIn, YouTube, Instagram, Snapchat, and TikTok. The applications may also include other multimedia, texting, and sharing applications, such as WhatsApp. In some embodiments, the detection that a user is active and interacting with their social media application may be made if the user is currently scrolling through their feed on their Facebook account, logged into their X (f.k.a. Twitter) account, posting on their Instagram account, consuming videos on their TikTok account, etc. The detection that a user is active and interacting with their social media application may also be made if the user likes, dislikes, shares, posts, or reposts, using a social media application. Basically, any time a user is logged in to the social media application via the user's social media account, performing any type of activity on the social media platform, such as spending time on a social media application, or even just gazing at the social media user interface provided by the social media application, such interaction may be associated with the user being currently active on the social media application.

In some embodiments, the social media account may be connected with the user's OTT account. As such, in one embodiment, when an activity or interaction with the post is performed by the user on the social media application, data associated with the activity or interaction may be available for the OTT to retrieve. In some instances, the post may have a button and the user presses the button, a service associated with the external app. may be invoked to provide data associated with the pressing of the button to the OTT service provider. In another embodiment, whenever an activity or interaction is performed by the user on the social media application, the social media server may notify the OTT service provider that the user is currently active on their social media application. In some embodiments, the notification from the social media server to the OTT service provider may only indicate that the user is currently active on the social media application and may not provide any additional details due to privacy concerns. For example, data relating to what the user is browsing or doing while using their social media application may not be shared. In some embodiments, there may be opt-in and opt-out options provided to the user for sharing user data, including the type of user activity performed by the user on their social media application, with the OTT service provider.

At block 104, the OTT service provider, in one embodiment, may select an image, scene, clip, that is personalized to the user and place the personalized image, scene, or clip in the user's feed and the user's feed may be determined based on user's credentials, such as user account ID. The personalization may be performed based on the user's preferences, such as those determined at block 102 or from user history or user profile. For example, the OTT service provider may determine that the user is active on their Facebook application, and as such, select an image, scene, or a clip and post it in the user's feed while the user is active on their Facebook application. In other embodiments, the OTT service provider may post a selected image, scene, or clip on a page of the social media application that is associated with the OTT service provider, such as Netflix's Facebook page (also referred to at OTT's page on the social media application). In yet more embodiments, the OTT service provider may post a selected image, scene, or clip in an advertisement, sponsored, or other section of the social media platform, such as an advertisement section that appears on the right side of the user interface on a Facebook platform or a sponsored section that appears at the start of an Instagram platform.

In another embodiment, the user may follow the OTT service provider, such as by selecting a follow option on a social media platform. As such, when the user follows the OTT service provider, a posting by the OTT service provider may be made visible to the user. In this embodiment, the control circuitry may trigger a dynamic content adjustment for that post when it first appears to the user or when it appears in the feeds of other users who also follow these organizations and have their accounts linked. For example, if a user follows the social media account of Netflix and does not have their Netflix account linked or shared with the social media network, the user may see the original post (and teaser, product post, etc.). However, if the user has their account shared or linked, they may see a modified version of the content that matches their recommendation profile.

In one embodiment, the post may include a button that allows the user to perform an action on the associated media asset when the OTT application is launched. For example, an option to “auto-play” the media asset associated with the post can result in the media asset being auto-played when the user launches the application at a later time.

In yet another embodiment, regardless of having the knowledge of whether the user is currently active on their social media application, the OTT service provider may select an image, scene, or a clip and post it either in the user's feed, in an advertised section that may be visible by the user on the social media application, or on the OTT service provider's page on the social media application such that whenever the user logs into their social media account, or is active on their social media application, the post made on the social media platform by the OTT service provider may be made visible to the user. In some embodiments, the selection of the image, scene, or clip to be posted in the user's feed may be performed after the user has interacted with the post and in other embodiments the selection may be performed irrespective of the user's earlier engagement with the post (e.g., the post may be posted in the user's feed which the user may consume when the user logs into their social media account using their account ID).

The selection of the image, scene, or the clip from the media asset may be based on the user's preferences determined at block 102. For example, if a determination is made that user 1 prefers comedy while user 2 prefers romance, then the OTT service provider may select different clips or scenes from the same media asset, such as the same movie, that play into the user's preferences and post related images, scenes, and clips on their social media applications that are associated with their specific social media accounts. In some embodiments, the process of selecting images, scenes, and clips to post in the user's feed may be after the user has interacted with the post and in other embodiments, it may be before the user interacts with the post.

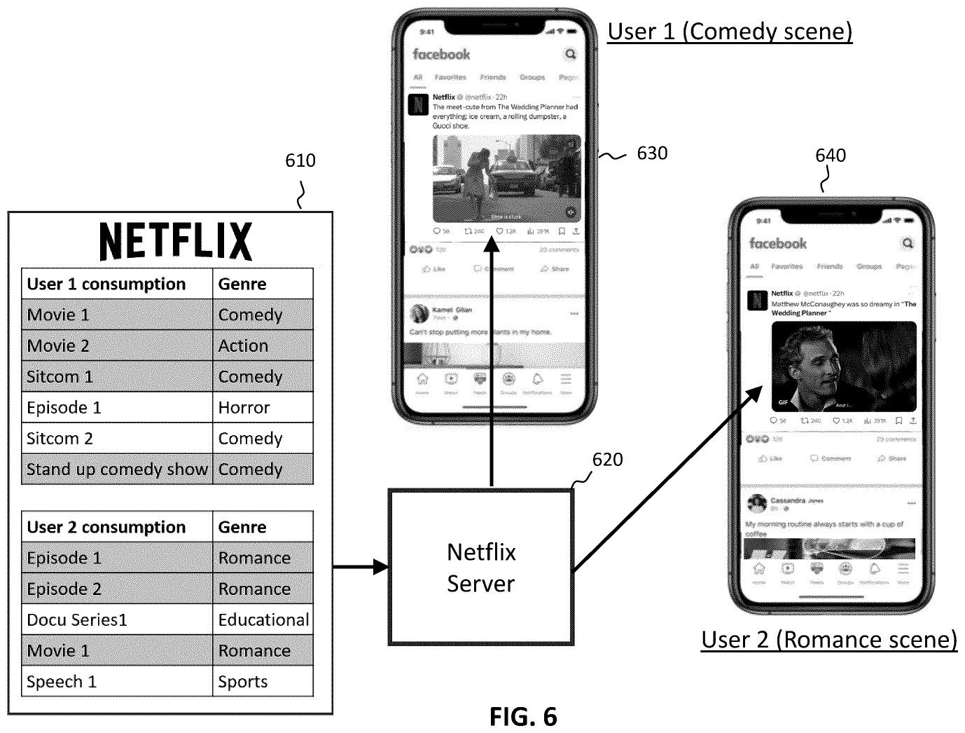

As described further in relation to FIG. 6, the OTT service provider may determine that user 1 enjoys comedy more than other genres while user 2 enjoys romance more than other genres. Accordingly, different scenes or clips from the same movie, such as the movie “The Wedding Planner,” may be selected for display on their associated social media applications. Since user 1 enjoys comedy more than other genres, a scene from “The Wedding Planner” that is associated with comedy may be displayed in user 1's feed or on the OTT service provider's page on the social media application such that when user 1 reaches the service provider's post, they may see a comedy scene that is displayed. For example, a comedy scene from “The Wedding Planner” where the actress's shoes are stuck in a vent on the roadside may be selected and posted by the OTT service provider. The posting may be specific to user 1's social media account such that the comedy scene is only seen by user 1. Likewise, since user 2 enjoys romance more than other genres, a scene from “The Wedding Planner” that is associated with romance may be displayed in user 2's feed or on the OTT service provider's page on the social media application such that when user 2 reaches the service provider's post, they may see a romance scene from the same movie displayed. The posting may be specific to user 2's social media account such that the romance scene is only seen by user 2.

By posting an image, scene, or a clip based on the user's preferences, the OTT service provider may increase the likelihood of the user engaging with the post more than having a post that generically shows an image, scene, or clip of the same movie that may not be of interest to the user. For example, a determination may be made by the OTT service provider based on user 1's consumption history of consuming media assets on their OTT service provider application when logged in through user 1's account, that user 1 dislikes horror and action genres.

For example, the service provider may automatically detect patterns of user's consumption, such as media assets that have a higher content of one genre (e.g., comedy) than another genre (e.g., romance) and based on the pattern detection associate the user interest with a particular genre. The service provider may also obtain metadata of the media assets consumed by the user, including, the characterization of the media asset, such as comedy, action, thriller, suspense, romance, etc., and use such metadata to determine the user's interest. Such determining of user interest, including a first and a second type of interest and the degree of the interest (e.g., first interest may be comedy 60% of the time and second interest may be romance 40% of the time) may then be used in determining which clip or scene to post for the user on the social media application. If such knowledge was not used in determining which clip to post on the user's feed, when an action-related image or clip is posted on the user's feed, then there may be a lesser likelihood of the user selecting or engaging with the post. Accordingly, to increase the likelihood of engagement with the post, the OTT service provider may analyze both the user's likes and dislikes (as determined at block 102) and select images and clips for the same media asset that play into the user's interests when posting on a social media application.

In some embodiments, the OTT service provider may embed instructions into its post to inform the social media application, or the server associated with the social media application, to change the thumbnail, image, or the clip based on which user is logging in to their service provider account. As such, based on the metadata embedded in the post, whenever a user logs in and reaches the post, the social media server may change the post based on the user's login credentials.

Further instructions that include what type of image or clip is to be displayed may also be provided from the OTT service provider to the social media application. For example, different images and clips may be shown to a same user depending on the time of day, week, or month when the user logs in to their social media account or when they reach the post provided by the OTT service provider. For example, instructions may be provided that if the user logged in to their social media account or reached the post in the morning, a different clip from the same movie shall be displayed as opposed to when the user logs in or reaches the post at an evening hour. This may be because the user enjoys a different genre in the morning than in the evening. For example, the user may enjoy a motivational or comedy scene in the morning to get a good start to their day and in the evening when they are more relaxed may enjoy a romantic scene. Such instructions may be based on the analysis performed by the OTT service provider at blocks 101 and 102 where the user's preferences on a granular basis based on the time of day, week, month or special occasions are previously determined.

In some embodiments, the user's genre preference may change over time. For example, a user that enjoys comedy may have shifted to enjoying action more. The control circuitry may track the user's consumption patterns and detect the changes in genre preferences. Based on the changes in genre preferences, the images, videos, posted on the social media for the user's consumption may be replaced with images and videos aligned with the new genre preference.

In some embodiments, a user, while consuming a media asset by logging into the OTT application via their user account, may fast-forward a position of a media asset that relates to a specific genre. The control circuitry may associate such fast-forwarding with user disliking the genre of that portion of the media asset, e.g., a fight, horror, or adult scene and may ensure that a scene associated with the genre is not posted on the social media for the user's consumption since the user dislikes such genre.

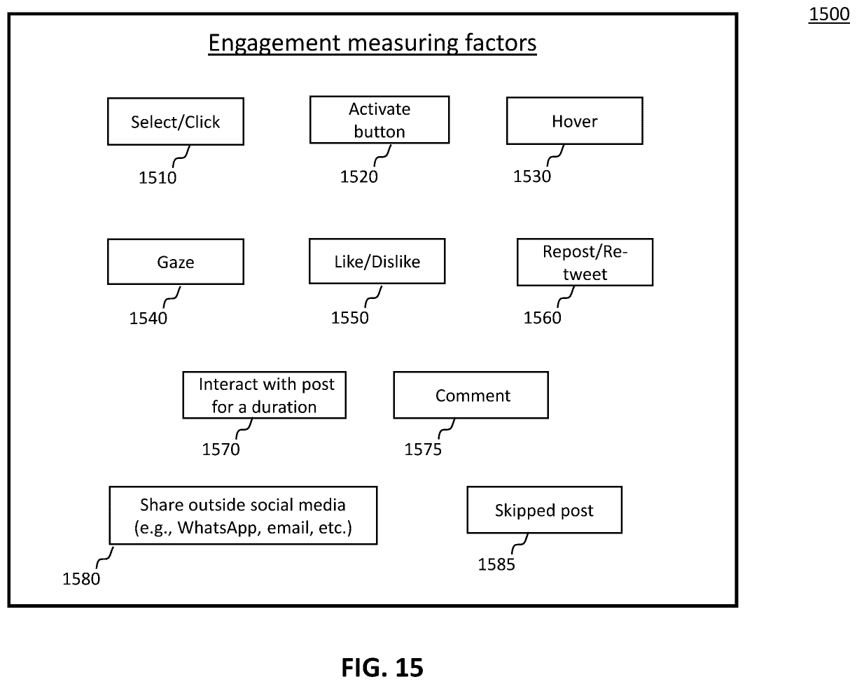

In some embodiments, once a post is made and a user interacts with the post, at block 107, engagement with the post may be monitored. For example, a determination may be made whether the user's engagement with the post is positive or negative or exceeds a predetermined score, also referred to as threshold score. Some examples of positive engagement may include the user liking the post, hovering over the post, gazing at the post, spending time looking at the post, or sharing the post. Some examples of negative engagement may include the user disliking the post or scrolling away or moving on from the post without spending a threshold amount of time on it. Some examples of exceeding a threshold, i.e. the predetermined score may include having a predetermined score for a level of engagement and determining whether the engagement with the post exceeds the predetermined score, i.e. the threshold. Another example of exceeding the threshold may be based on the type of comment posted by the user. In this embodiment, the words and the sentiment may be analyzed by an AI engine to determine the degree of positive and negative engagement and compared to a positive/negative scale and a score may be computed based on the comparison. Additional engagement measuring factors are described further in relation to FIG. 15.

At block 108, based on monitoring the user's engagement with the post, the user preferences determined at block 102 may be adjusted. In other words, actual engagement with the post and metrics of the engagement may be taken as feedback and analyzed to update or refine the user's preferences such that future posts may consider any updates. As such, when a future post is to be made, updated preferences may be factored in, and an image or clip that is related to the updated user preferences may be selected for posting in the social media application for an account associated with the user. The monitoring of the user's engagement with the post, metrics related to the engagement, and adjustment of preferences described in blocks 107, 108 and 102 may be performed on a continuous basis to keep the user's preferences current and use them for future posts.

FIG. 1B is a block diagram of a process 110 for activating a wallpaper or screen saver or recommending a media asset on an OTT application for the user's account based on the user's engagement with a social media post, in accordance with some embodiments of the disclosure. The process 110 may be implemented, in whole or in part, by systems or devices such as those shown in FIGS. 2-3. One or more actions of the process 110 may be incorporated into or combined with one or more actions of any other process or embodiments described herein. The process 110 may be saved to a memory or storage (e.g., any one of those depicted in FIGS. 2-3) as one or more instructions or routines that may be executed by a corresponding device or system to implement the process 110.

Process 110 may allow an OTT service provider, such as Netflix, Hulu, Disney, Amazon, Apple, ESPN, and others to either change screen savers or wallpapers on the OTT application or provide media asset recommendations on the OTT application associated with a user account based on the user's engagement with a post on a social media application, which is a separate application from the OTT application. By doing so, the OTT service provider may be able to provide customizations, personalization, and recommendations to the user's service provider account that increase the user's interaction with the service provider platform as well as provide recommendations that are relevant to the user's interests.

The process 110 includes, at block 111, an image, clip, video, or any other form of content posted on the user's social media account. In some embodiments, the posting on the social media application may be made by the OTT service provider, and in other embodiments, the posting may be made by anyone else.

In some embodiments, the posting may be from a media asset that is offered by the service provider. For example, the posting may be an image, clip, or video from a movie that is offered by the service provider, such as scenes from the movie “Top Gun” featuring Tom Cruise. The posting may also be a text posting without any image that mentions an upcoming movie in which Tom Cruise is an actor.

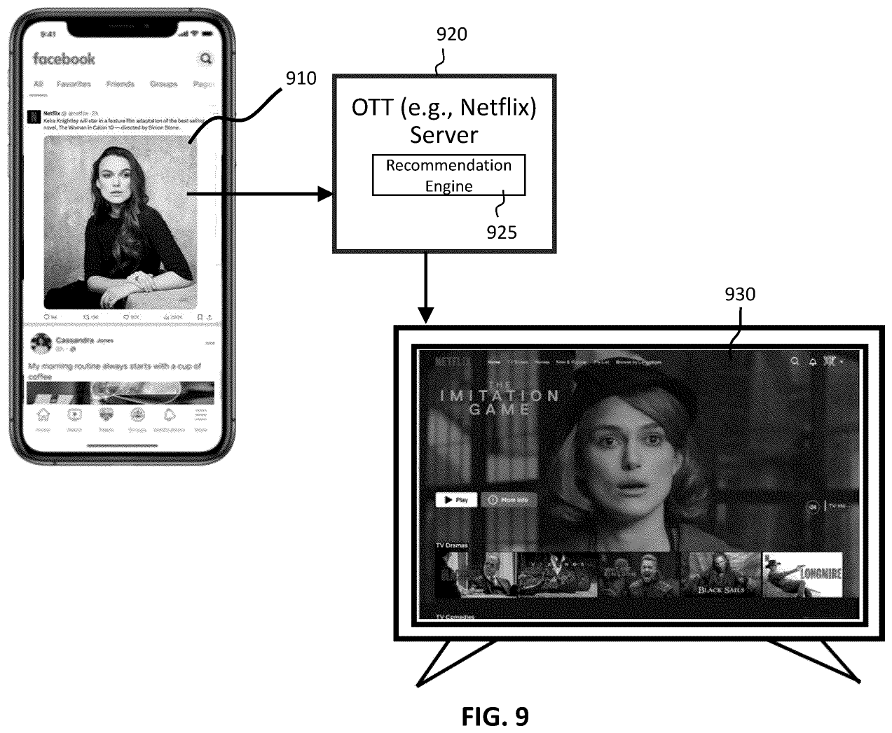

In another embodiment, the posting may not be from a media asset that is offered by the service provider. However, attributes of the posting may relate to media assets provided by the service provider. For example, as depicted in FIG. 9, an image of actress Keira Knightley may be posted on the social media application. The image may have no direct connection to any media asset offered by the OTT service provider. For example, the posting may relate to Keira Knightley's personal life or her being spotted in public at a restaurant, or any other information related to Keira Knightley. The posting may also not mention any names of movies or other types of media assets in which Keira Knightley acted. In some embodiments, the posting may be an image, or a clip related to Keira Knightley while in other embodiments, the posting may simply be information that uses the words Keira Knightley and may not contain an image or a clip. In terms of the posting including attributes relating to media assets provided by the service provider, one of the attributes may be the image or mention of the actress Keira Knightley which relates to a movie, “Imitation Game,” in which the Keira Knightley is an actress, and which is offered by the service provider.

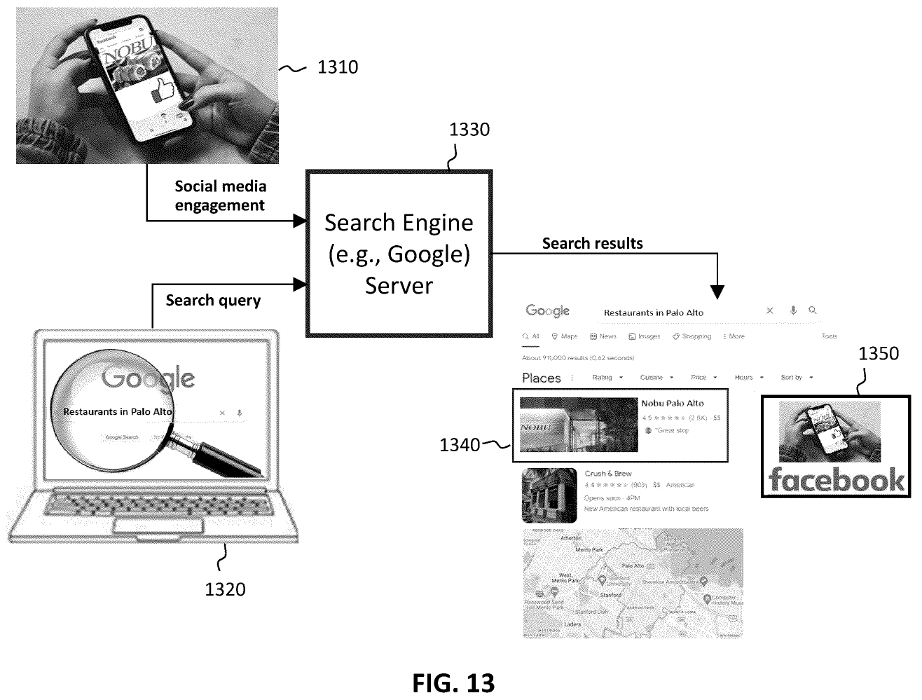

In some embodiments, information and engagement metrics data relating to the user's engagement with a post may be provided from the social media application, such as via the social media server, to the OTT application, such as via the OTT server. In some embodiments, as further described in FIG. 13, the type of data and information relating to the user's engagement with the post that can be shared by the social media server with the OTT service provider server may be based on opt in and opt out privacy options provided to the user. For example, in some embodiments, the user may opt out of sharing certain details relating to their engagement with a particular post. The user may also input into their social media profile the types of information and data that can be shared with the OTT service provider. The user may also restrict data relating to the user's engagement with certain genre of posts from being shared with the OTT service provider. For example, the user may restrict data related to their engagement with posts that are rated-R or of adult content from being shared with the OTT service provider.

In some embodiments, when a user opts in to sharing the social media interactions with the OTT service provider, the user's ID, post ID, and engagement metrics may be shared with the OTT service provider. In some embodiments, if the user links their social media account with their OTT service provider account, the terms and conditions related to sharing may include the type of data that the user authorizes for sharing between the two applications. In some embodiments, a link may be established for the user accounts from different application automatically if the user permits the control circuitry to do so. In this embodiment, the control circuitry may crawl and identify all user account on different applications and link them such that date from one application may be shared with another application without the sharing application being informed the purpose or use of the shared data due to an effort to maintain user privacy.

When a post ID, a user ID, and optionally engagement metrics and measuring factors (as depicted in FIG. 15), if user opts in, are shared by the social media application with the OTT service provider application, the OTT service provider may analyze the information received from the social media application and perform an action from a list of possible actions on the OTT application. The type and nature of actions performed by the OTT service provider on the OTT application associated with the user's account, based on information received from the social media application relating to the user's engagement with a post, in some embodiments, may not be shared back with the social media application. In other words, the OTT service provider's actions may be kept private from the social media application.

The list of possible actions that can be performed by the OTT application, based on information received from the social media application relating to the user's engagement with a post, may include customizing wallpaper, a screen saver, or artwork on either a landing page of the OTT application associated with the user's account or on one or more pages of the OTT application. Another possible action that may be performed by the OTT application may include recommending media assets based on the information received from the social media application relating to the user's engagement with a post. Yet another possible action that may be performed by the OTT application may include saving a link to the recommended media assets based on the information received from the social media application relating to the user's engagement with a post in a user's wishlist. Another possible action that may be performed by the OTT application may include recommending a media asset that is relevant to multiple users in a family. Although a few possible use cases of the OTT service provider's use of information received from the social media application relating to the user's engagement with a post are described, the embodiments are not so limited, and other use cases may also be performed to enhance and personalize the user's experience on the OTT application. Likewise, although the possible use cases and related actions are described as being performed by the OTT service provider, the embodiments are not so limited, and, the use of information and the actions taken may also be performed at the device level. For example, the OTT service provider may recognize the device associated with the user, based on the user ID, and provide instructions to the device for performing the actions that are described above as being performed by the OTT service provider. In the event the device locally stores a plurality of media assets, the instructions provided by the OTT service provider, or based on information received from the social media platform, the device may provide recommendations of media assets from the media assets stored locally on the device or at a remote storage connected to the device.

In some embodiments, two use cases relating to generating screen savers or wallpapers and recommending media assets to the user are described via option A (blocks 112-113) and option B (blocks 114-116).

In some embodiments, once user data relating to the user's engagement with the social media post is received by the OTT service provider associated with the OTT service provider application, which may include post ID, user ID, user engagement metrics, associated engagement measuring factors, and any other information relevant to the user's engagement with the post, the OTT service provider may determine whether such an engagement with the social media post should be used to present or customize a screen saver or wallpaper on the user's OTT application.

With respect to option A at block 112, in one embodiment, the OTT service provider may post an image, clip, or video on a social media application, such as in a user's feed or on the OTT application's page on the social media application. The OTT service provider may, at block 112, include an activate button, icon, text, or other option provided to the user to activate a screen saver (not shown in figure) or wallpaper on the user's account associated with the OTT application. If the user selects the activate button on the post in the social media, then such selection of activation information may be sent from the social media server to the OTT server. The OTT server may receive the post ID and user ID, based on which the OTT server, at block 113, may map a corresponding action, such as downloading an image and configuring the user's OTT account. By doing so, when the user logs in to the OTT application, the image from the social media post may be displayed as a screen saver or a wallpaper.

In some embodiments, an activation option may be displayed only when a user engages with a post on social media. Upon engaging, the activation option may be displayed as a pop-up, in line with the posted image or its text, or as a link in proximity of the post. If the user selects the activate option, activation information, such as post ID and user ID, may be sent to the OTT server. The service provider may map the post ID to an action, which in this case may be to download a screen saver or a wallpaper. Since the OTT service provider is the one that made the post on the social media server, the post ID may be stored in the service provider's database and associated with an action to download a screen saver or wallpaper. In some embodiments, the OTT service provider may maintain a list of post IDs and their associated actions in the database. As such, if information is received from the social media server that the post with the post ID was engaged with by the user, the service provider may then determine the action associated with the post ID from the maintained list. The OTT server may then download the image that the user interacted with in their social media application on the OTT application and present it to the user when the user logs in using their OTT account on the OTT application.

One example of providing a screen saver or a wallpaper on the OTT application based on user's engagement of the social media post is described next. In this example, the social media account on X for Apple TV may create a post about a new Ted Lasso Screensaver that is available on an Apple TV device. The poster could add a tag or markup language indicating an activate button or that a repost is considered an activation. When users click the activate button or repost the post, the callback is triggered along with parameters such as the post ID, the type of action (activate or repost), the social media/organization user profile ID among others. When the callback is received by Apple, the Apple TV device which is linked to the Apple User ID associated with the social user profile ID is instructed to download the new Ted Lasso Screensaver and to activate it as the current screen saver for that device.

Although the embodiments described above with respect to blocks 112 and 113 relate to the OTT service provider posting the image, clip, or video, the embodiments are not so limited, and an image, clip, or video posted by anyone else is also contemplated within the embodiment. In such a scenario, when an image, clip, or video is posted by someone else other than the OTT service provider, the post ID may not have much meaning to the OTT service provider since the OTT service provider will not have a pre-assigned mapping for a post that is posted by someone else other than the OTT service provider. When the OTT service provider is the one that posts the social media post, it maintains a pre-assigned mapping on the OTT service provider's end that associates the post ID with an action. As such, when someone else other than the OTT service provider posts on social media, in one embodiment, the process may include the social media server providing the metadata associated with the post, engagement metrics, and the user ID to the OTT service provider. The OTT service provider may then determine whether it provides a media asset that is relevant to the post, and if so, the metadata shared may be used by a recommendation engine of the OTT service provider to recommend media assets on the OTT application when the user logs in using their account. In another embodiment, the OTT service provider may provide a list of keywords to the social media server, and instead of the OTT service provider receiving the metadata and performing the matching to a media asset, the social media server may perform the task based on instructions provided by the OTT service provider. In such a scenario, the social media server may receive the list of keywords from the OTT service provider, and then, if metadata of a post engaged with by the user matches the list of keywords, only then will the social media server transmit metadata of the post, user ID, and engagement metrics to the OTT service provider.

One example of someone else posting an image, clip, or video on the social media platform other than the OTT service provider may be a friend or a colleague of the user posting their vacation pictures on a social media platform, and the pictures may appear on the user's social media feed. For example, a first friend of the user may post their vacation pictures from New York and a second friend of the user may post pictures of their vacation from Paris. Although such images may not have a direct correlation with a movie or a media asset, metadata associated with such images may be analyzed to determine whether any attributes of the pictures match a media asset that is offered by the OTT service provider.

For example, regarding the first friend, if the user engages with the vacation pictures that depict the New York City skyline, such as the Empire State Building, such metadata may be either transmitted to the OTT service provider or analyzed by the social media server based on criteria provided by the OTT application to determine whether a media asset offered by the OTT service provider includes attributes of the social media picture with which the user had a positive engagement. If the OTT service provider, such as Netflix, offers the movie “King Kong,” which depicts King Kong on top of the Empire State Building, i.e., matches the attributes of the social media picture which also shows the Empire State Building, then such a media asset may be determined to be of interest to the user. As such, the OTT service provider may obtain such a recommendation from its recommendation engine and select an image from the movie that depicts the Empire State Building to show on the landing page of the OTT application for the user's account.

In another example, vacation pictures from Paris posted by the second friend may also be shown in the social media feed of the user. Since the user's social media account may be linked to their OTT application, such as Netflix, if the user positively engages with the post, such post details, engagement metrics, and user ID may be provided to the OTT server. The OTT server may analyze the image (i.e., the vacation pictures from Paris that the user liked) and determine whether a media asset provided by the OTT service provider matches the post. The matching may be of one of a plurality of types. In one embodiment, the OTT server may perform an image analysis. This may include the OTT server matching an image of the post with an image in a media asset. In another embodiment, the OTT server may determine whether a media asset that includes one or more attributes of the social media post, or one of the images from the media asset that is in the same location of the social media post is provided by the OTT service provider to determine a match. If the OTT service provider, for example, offers the movie “The Da Vinci Code,” a lot of which takes place in Paris, including scenes where Tom Hanks is shown in and around the Louvre (a museum in Paris), then the OTT server may determine a match between the post on the social media with which the user positively engaged and the media asset offered by the OTT application. Accordingly, the recommendation engine associated with the OTT application may recommend displaying “The Da Vinci Code” as a suggestion on the landing page, or any other page, of the OTT application when the user logs in to their account associated with the OTT application. The OTT application may also recommend one of the scenes from Paris to further pique the user's interest. As such, even vacation pictures, pictures of products, and other images posted on social media may be used by the OTT server, or by a marketplace server such as Amazon, to recommend media assets and products by displaying them on the landing page or any other page of their application that is associated with the user account.

Referring to blocks 114-116, listed as option B in FIG. 1B, once a posting is posted on social media, by the OTT service provider or by someone else, as described above in relation to blocks 112 and 113, a determination may be made whether the user engagement with the post is a positive or a negative engagement at block 114. Positive engagement may be related to the user having an interest in the content of the post and may be determined based on the user liking the post, hovering over the post, gazing at the post, spending time looking at the post, or sharing the post. A negative engagement may be related to the user not having interest in the post, and such determination may be made when the user dislikes the post or scrolls away from the post without spending a threshold amount of time on it. Additional engagement measuring factors are described further in relation to FIG. 15.

At block 115, whether the engagement is positive or negative or exceeds a threshold score, engagement metrics and user preferences associated with the engagement are obtained and analyzed. In some embodiments, based on the user's positive engagement with the post, a determination may be made that the user likes comedy and action and likes the actress, Keira Knightley. This may be because the post includes a description or some reference to the actress Keira Knightley, and the user has either hovered over the post, liked the post, shared the post, or perform other positive engagement as referred to in FIG. 15. Engagement metrics from the positive engagement may be obtained and transmitted to the OTT service provider. The OTT service provider may analyze the received engagement metrics and store them in association with the user's interests and preferences such that such user preferences may be used in recommending media assets associated with such user preferences to the user on the OTT application.

In another example, a post that includes a horror scene and an image of the actor Chris Pratt may be posted in the user's social media feed. In the post, a horror scene from the movie “Jurassic Park” where a dinosaur may be eating a human may be depicted. In this example, the user may have either “disliked” the post or scrolled away from the post without pausing or spending any time on it. As such, a determination may be made that the user's engagement with the post is a negative engagement. Engagement metrics from the negative engagement may be obtained and transmitted to the OTT service provider. The OTT service provider may analyze the received engagement metrics and store them in association with the users dislikes and disinterest such that media assets associated with such dislikes and disinterests may not be recommended to the user on the OTT application.

At block 116, the OTT application may receive metadata, user ID, post ID and engagement metrics associated with the positive engagement and provide them to a recommendation engine associated with the OTT application. The recommendation engine may then use the metadata to query media assets offered by the OTT application. The recommendation engine may then recommend media assets on the OTT application that match the user's interests and preferences when the user logs in to the OTT application. As such, when the user logs in to the OTT application, the landing page may show one or more media assets that are related to one or more attributes of the social media post with which the user had positive engagement. For example, as described in block 115, if the user had a positive engagement with the post that included the actress Keira Knightley, when the user logs in to the OTT application, a recommendation of a movie “Imitation Game,” which stars Keira Knightley, may be depicted on the landing page of the user account associated with the OTT application.

In some embodiments, the post is created (for example by a user of a verified organization or OTT service provider), the organization or posting user may indicate that this post is a recommendation influencing post. For example, an actress in the post about “The woman in cabin 10” may also be the same actress in “The Imitation Game”. If a user engages with the post of the woman or the post of “The woman in cabin 10,” and if their recommendation in the Netflix system indicates that they like dramatic and suspenseful movies, the Netflix application may promote “The Imitation Game” to the user since it includes the same woman in the post with which the user may have positively interacted.

Referring back to block 111, in some embodiments, in both options (blocks 112-113 and blocks 114-116), the post made by the OTT service provider may include a master or specific post ID. When users engage with posts that contain the master or specific post ID, the posting user's system may receive a callback when users engage with the post. Using this callback and or ID, the user's engagement is reported back to the verified OTT service provider that made the post, e.g., organization user's system (in this case a Netflix API endpoint). As user's engagement with the post, repost or otherwise interaction with the post, their Netflix profile may be updated to reflect the potential interest in related or similar content. In the case of the above mentioned activate button at block 112, the click by the viewing social media user is transmitted back to Netflix along with the post ID. This call back may now be used by Netflix to alter the functionality of the Netflix application for the user profile that was linked to the social media account. The activate or similar button combined with the unique ID and metadata tag of the post may also create a level or privacy as the feature or function within the Netflix application is not exposed to the social media network.

FIG. 1C is a block diagram of a process 120 for enhancing search results based on the user's engagement with a social media post, in accordance with some embodiments of the disclosure. The process 120 may be implemented, in whole or in part, by systems or devices such as those shown in FIGS. 2-3. One or more actions of the process 120 may be incorporated into or combined with one or more actions of any other process or embodiments described herein. The process 120 may be saved to a memory or storage (e.g., any one of those depicted in FIGS. 2-3) as one or more instructions or routines that may be executed by a corresponding device or system to implement the process 120.

Process 120 may be used with a search engine, such as Google, Yahoo, or Bing, including maps search engines such as Google Maps, Apple Maps, MapQuest, Bing Maps, Waze, and other types of category-specific search engines, such as search engines that allow searches of restaurants (e.g., Yelp), travel (e.g., Expedia, Kayak, Priceline, Google Travel), products (e.g., Amazon, Walmart, Best Buy, Target), and other services (e.g., search engines of doctors, dentists, plumbers, accountants, tax preparers, mortgage services, etc.). Process 120 may allow the search engines to provide search results along with displaying associated social media engagement with the search, such as displaying Facebook posts that the user engaged with next to the search results. Process 120 may allow the search engines to rank the search results and display them in an order based on user interests determined from the user engaging in a post on social media, e.g., a product, service, or media asset, that the user positively engaged with on social media, if some of the search results may be displayed higher in order than other search results. If the user positively engaged with a post on social media, and one or more attributes of the post are related to a first search result, from the plurality of search results, then the first search results may be shown by the search engine at a higher order than the remaining search results.

The process 120 includes, at block 121, detecting user engagement with a post, such as an image, clip, video, or any other form of content on the user's social media feed or on a specific page on the social media application. The post on the social media may be of any type, such as vacation pictures, images from a media asset, product images, video clips, or textual description of a place, object, person, product, etc.

At block 122, the control circuitry may analyze user engagement with the post. In some embodiments, a user may have either hovered over the post, “liked” the post, shared the post, or performed other positive engagement as referred to in FIG. 15. In other embodiments, the user may have engaged with the post in a negative manner. A negative engagement may be related to the user not having interest in the post, and such determination may be made when the user “dislikes” the post or scrolls away from the post without spending a threshold amount of time on it. Additional engagement measuring factors are described further in relation to FIG. 15.

At block 123, user preferences based on the type of engagement may be determined. This may include determining detailed engagement metrics that include details of what the user likes and dislikes, and attributes associated with each like/user interest. For example, as depicted in block 123, the user may have “liked” an image posted in block 121 on social media, which is an image of a sushi restaurant, the Nobu restaurant in Palo Alto. Based on analyzing the user's positive engagement, user preferences may be determined. These preferences in this example may indicate that the user likes the restaurant Nobu and also likes sushi.

At block 124, in some embodiments, the user ID, the post details, the engagement metrics, and related user preferences may be provided to one or more search engines and/or marketplaces. In other embodiments, the social media server may obtain the user ID, post details, and engagement metrics and transmit them to the search engines and marketplaces with whom the user has an account and has authorized sharing of such data. The search engines and marketplaces may then perform their own analysis based on the received data to determine whether the user's interests are relevant to a search conducted by the user.

At block 125, the user may enter a search, such as in the search engine for Google, Amazon, Google Maps, Yelp or another platform. The search engine or the marketplace platform, based on the search query at block 125, may then return the results of the search at block 126. In some embodiments, the user's engagement with the social media post, whether positive or negative or exceeds a threshold score, may be factored in to determine how to present the search results to the user. For example, if the user is interested in a particular restaurant, vacation place, or object, then vacation places, restaurants, or objects may be provided higher up in the search results if they correspond to the query entered at block 125. Likewise, if the search results were to include a specific restaurant, vacation place, or object, but a determination is made based on a negative engagement with a post in social media that the user dislikes that specific restaurant, vacation place or object, then such a search result (e.g., vacation place, restaurant, object) may be eliminated from being presented to the user or be presented much lower in the ranking order due to lack of interest determined. In some embodiments, the search engine may also present the social media post and the user's engagement with the post in the vicinity of the search results. For example, along with the search results, the search engine may present that Facebook post and an indication that the user liked the Facebook post.

The embodiments of FIG. 1C enhance the search results for a search query by integrates social media insights. For example, when a search query is entered, if a topic of the search query matches a social media post with which the user may have interacted, then the control circuitry, such as the control circuitry 200 and/or 228 of system in FIG. 2, integrates social media insights into external application search results, such as mapping or review platforms. This integration is designed to enhance the relevance and personalization of search results by including posts from social media users that a person follows, has publicly reposted or liked or otherwise has consented to be shared to third-party applications. For example, if a user frequently interacts with or follows another user on a social media platform like X, and this followed user posts about a local or regional restaurant, the system captures this data and integrates it into related search queries on external applications. The system uses APIs to extract and synthesize data about posts related to specific topics—such as dining, entertainment, or travel—from social media platforms. This data includes metadata of the posts, such as geographical tags, content descriptions, and engagement metrics. When a user performs a search on an external application like Apple Maps for similar topics, the system injects relevant social media posts into the search results. This method effectively turns posts from followed users into personalized recommendations, appearing alongside traditional search results. To ensure relevance, the system filters the results to match the content of the social media posts with the user's search parameters. For instance, if the user searches for “Italian restaurants near me” and a followed user has recently posted about an Italian restaurant, that post, along with a summary and a link to the full social media content, appears in the search results. This approach not only provides contextual relevance based on the user's social circle but also enhances the decision-making process by incorporating trusted recommendation.

In some embodiments, user accounts for a specific user may be linked thereby allowing sharing of data between the applications. For example, as depicted in FIGS. 1A-1C, user accounts associated with the social media applications, OTT applications, search applications may be linked such that when the same user performs an action on one of the applications, such as the social media application, then the metadata associated with such engagement and actions may be reported to other applications and used for performing functions on the other applications.

FIG. 2 is a block diagram of an example system 200 that can be used for performing the disclosed embodiments, in accordance with some embodiments of the disclosure. FIG. 2 can also be used for leveraging social media engagement with a post or leveraging OTT consumption by a user to provide recommendations, perform actions, and provide engagement-influenced search results in a separate application, in accordance with some embodiments of the disclosure.

FIGS. 2 and 3 also describe example devices, systems, servers, and related hardware that may be used to implement processes, functions, and functionalities described at least in relation to FIGS. 1A-1C, and 4-21. Further, FIGS. 2 and 3 may be used at least for monitoring user consumption history on a first application, such as an OTT application, analyzing the monitored user consumption to determine user preferences, and based on the monitoring and analysis, selecting an image, scene, or video that is aligned with the determined user preferences, and posting the selected image, scene, or video on a second application, e.g., a social media application, that is distinct from the first application, such that when a user logs in to their social media account, the image, scene, or video that is aligned with their preferences determined at the first application is displayed to the user.

FIGS. 2 and 3 may also be used at least for monitoring user interaction with a post on social media application and determining whether the interaction is a positive or negative interaction or exceeds a threshold score, performing an action on a different application, e.g., an OTT application that is distinct from the social media application on which the interaction with the post took place, based on the determined type of interaction, configuring a screen saver or a wallpaper on the OTT application for the user's account such that when the user logs in using their account to the OTT application, displaying on the OTT application, a screen saver or a wallpaper having the same image, scene, or video clip as the post with which the user engaged positively in the social media application, configuring one or more media asset recommendations that are related to the post on the OTT application for the user's account such that when the user logs in using their account to the OTT application, the recommendations of media assets that are related to the post with which the user engaged positively in the social media application are displayed on the OTT application.

FIGS. 2 and 3 may also be used at least for monitoring user interaction with a post on social media and determining whether the interaction is a positive or negative interaction and based on the type of interaction, i.e., positive, or negative, enhancing search results for a search query entered in a search engine (such as Google, Yahoo, Bing, etc.) by integrating social media insights, receiving search queries on a search engine, when a search query is entered, if a topic of the search query matches a social media post with which the user may have interacted, then integrating social media insights into external application search results, such as mapping or review platforms, to enhance the relevance and personalization of search results by including posts from social media users.

FIGS. 2 and 3 may also be used at least for facilitating reposting of posts that a user has interacted with on the social media application via their social media account, such as by providing a one-click reposting feature along with an automated tracking system that compiles and summarizes user interactions with a plurality of posts to generate dynamic content summaries that capture the nature and depth of the user interaction, dynamically generating curated content summaries, making the summaries and the posts associated with the summaries available for easy reposting using the single button click feature

FIGS. 2 and 3 may also be used at least for providing a cross-platform reposting feature that allows users to share selected content from one social media platform to another, categorizing posts automatically based on their content type, utilizing natural language processing and image recognition technologies to analyze the content of each post and classifying it, and automatically cross posting to one or more social media platforms based on the post's categorization. FIGS. 2 and 3 may also utilize NLP, AI, and ML engines to execute associated algorithms for determining various solutions described herein, and performing functions related to all other processes and features described herein.

In some embodiments, one or more parts of, or the entirety of system 200, may be configured as a system implementing various features, processes, functionalities and components of 1A-1C, and 4-21. Although FIG. 2 shows a certain number of components, in various examples, system 200 may include fewer than the illustrated number of components and/or multiples of one or more of the illustrated number of components.

System 200 is shown to include a computing device 218, a server 202 and a communication network 214. It is understood that while a single instance of a component may be shown and described relative to FIG. 2, additional instances of the component may be employed. For example, server 202 may include, or may be incorporated in, more than one server. Similarly, communication network 214 may include, or may be incorporated in, more than one communication network. Server 202 is shown communicatively coupled to computing device 218 through communication network 214. While not shown in FIG. 2, server 202 may be directly communicatively coupled to computing device 218, for example, in a system absent or bypassing communication network 214.

Communication network 214 may comprise one or more network systems, such as, without limitation, an internet, LAN, WIFI or other network systems suitable for audio processing applications. In some embodiments, system 200 excludes server 202, and functionality that would otherwise be implemented by server 202 is instead implemented by other components of system 200, such as one or more components of communication network 214. In still other embodiments, server 202 works in conjunction with one or more components of communication network 214 to implement certain functionality described herein in a distributed or cooperative manner. Similarly, in some embodiments, system 200 excludes computing device 218, and functionality that would otherwise be implemented by computing device 218 is instead implemented by other components of system 200, such as one or more components of communication network 214 or server 202 or a combination. In still other embodiments, computing device 218 works in conjunction with one or more components of communication network 214 or server 202 to implement certain functionality described herein in a distributed or cooperative manner.

Computing device 218 includes control circuitry 228, display 234 and input circuitry 216. Control circuitry 228 in turn includes transceiver circuitry 262, storage 238 and processing circuitry 240. In some embodiments, computing device 218 or control circuitry 228 may be configured as electronic device 300 of FIG. 3.

Server 202 includes control circuitry 220 and storage 224. Each of storages 224 and 238 may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 4D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Each storage 224, 238 may be used to store various types of content (e.g., user interaction/engagement with posts, types of engagement and engagement metrics associated with each interaction/engagement with the posts, links associated with each post, generated and curated summaries for user interacted social media posts, user preferences, such as in types of genre, user selection of activation options, wallpapers and screensavers for displaying on OTT applications associated with user account, user ID, post ID, association of each post with a function to be performed, mapping of search results with social media posts with which the user interaction, both positive and negative engagement details, user account details associated with different social media applications, and NLP, AI and ML algorithms). Non-volatile memory may also be used (e.g., to launch a boot-up routine, launch an app, render an app, and other instructions). Cloud-based storage may be used to supplement storages 224, 238 or instead of storages 224, 238. In some embodiments, data relating to user interaction/engagement with posts, types of engagement and engagement metrics associated with each interaction/engagement with the posts, links associated with each post, generated and curated summaries for user interacted social media posts, user preferences, such as in types of genre, user selection of activation options, wallpapers and screensavers for displaying on OTT applications associated with user account, user ID, post ID, association of each post with a function to be performed, mapping of search results with social media posts with which the user interaction, both positive and negative engagement details, user account details associated with different social media applications, and NLP, AI and ML algorithms and data relating to all other processes and features described herein, may be recorded and stored in one or more of storages 212, 238.

In some embodiments, control circuitries 220 and/or 228 executes instructions for an application stored in memory (e.g., storage 224 and/or storage 238). Specifically, control circuitries 220 and/or 228 may be instructed by the application to perform the functions discussed herein. In some implementations, any action performed by control circuitries 220 and/or 228 may be based on instructions received from the application. For example, the application may be implemented as software or a set of executable instructions that may be stored in storage 224 and/or 238 and executed by control circuitries 220 and/or 228. In some embodiments, the application may be a client/server application where only a client application resides on computing device 218, and a server application resides on server 202.

The application may be implemented using any suitable architecture. For example, it may be a stand-alone application wholly implemented on computing device 218. In such an approach, instructions for the application are stored locally (e.g., in storage 238), and data for use by the application is downloaded on a periodic basis (e.g., from an out-of-band feed, from an internet resource, or using another suitable approach). Control circuitry 228 may retrieve instructions for the application from storage 238 and process the instructions to perform the functionality described herein. Based on the processed instructions, control circuitry 228 may determine a type of action to perform in response to input received from input circuitry 216 or from communication network 214. For example, the control circuitry 228, in response to determining that a user has positively interacted with a post, dynamically generate a summary for the post or provide the details of the positive interaction to an OTT application. The control circuitry 228 may also perform steps of processes described in 1A-1C, and 4-21.

In client/server-based embodiments, control circuitry 228 may include communication circuitry suitable for communicating with an application server (e.g., server 202) or other networks or servers. The instructions for carrying out the functionality described herein may be stored on the application server. Communication circuitry may include a cable modem, an Ethernet card, or a wireless modem for communication with other equipment, or any other suitable communication circuitry. Such communication may involve the internet or any other suitable communication networks or paths (e.g., communication network 214). In another example of a client/server-based application, control circuitry 228 runs a web browser that interprets web pages provided by a remote server (e.g., server 202). For example, the remote server may store the instructions for the application in a storage device. The remote server may process the stored instructions using circuitry (e.g., control circuitry 228) and/or generate displays. Computing device 218 may receive the displays generated by the remote server and may display the content of the displays locally via display 234. This way, the processing of the instructions is performed remotely (e.g., by server 202) while the resulting displays, such as the display windows described elsewhere herein, are provided locally on computing device 218. Computing device 218 may receive inputs from the user via input circuitry 216 and transmit those inputs to the remote server for processing and generating the corresponding displays. Alternatively, computing device 218 may receive inputs from the user via input circuitry 216 and process and display the received inputs locally, by control circuitry 228 and display 234, respectively.

Server 202 and computing device 218 may transmit and receive content and data such as details relating to user interaction/engagement with posts, types of engagement and engagement metrics associated with each interaction/engagement with the posts, and generated and curated summaries for user interacted social media posts. Control circuitry 220, 228 may send and receive commands, requests, and other suitable data through communication network 214 using transceiver circuitry 260, 262, respectively. Control circuitry 220, 228 may communicate directly with each other using transceiver circuits 260, 262, respectively, avoiding communication network 214.

It is understood that computing device 218 is not limited to the embodiments and methods shown and described herein. In nonlimiting examples, computing device 218 may be an electronic device, a personal computer (PC), a laptop computer, a tablet computer, a WebTV box, a personal computer television (PC/TV), a PC media server, a PC media center, a handheld computer, a mobile telephone, a smartphone, a mixed reality device, or any other device, computing equipment, or wireless device, and/or combination of the same that is capable of performing the embodiments disclosed herein.

Control circuitries 220 and/or 218 may be based on any suitable processing circuitry such as processing circuitry 226 and/or 240, respectively. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors, for example, multiple of the same type of processors (e.g., two Intel Core i9 processors) or multiple different processors (e.g., an Intel Core i7 processor and an Intel Core i9 processor). In some embodiments, control circuitries 220 and/or control circuitry 218 are configured for monitoring user consumption history on a first application, such as an OTT application, analyzing the monitored user consumption to determine user preferences, and based on the monitoring and analysis, selecting an image, scene, or video that is aligned with the determined user preferences, and posting the selected image, scene, or video on a second application, e.g., a social media application, that is distinct from the first application, such that when a user logs in to their social media account, the image, scene, or video that is aligned with their preferences determined at the first application is displayed to the user. In yet other embodiments, control circuitries 220 and/or control circuitry 218 are configured for monitoring user interaction with a post on social media application and determining whether the interaction is a positive or negative interaction, performing an action on a different application, e.g., an OTT application that is distinct from the social media application on which the interaction with the post took place, based on the determined type of interaction, configuring a screen saver or a wallpaper on the OTT application for the user's account such that when the user logs in using their account to the OTT application, displaying on the OTT application, a screen saver or a wallpaper having the same image or video clip as the post with which the user engaged positively in the social media application, configuring one or more media asset recommendations that are related to the post on the OTT application for the user's account such that when the user logs in using their account to the OTT application, the recommendations of media assets that are related to the post with which the user engaged positively in the social media application are displayed on the OTT application. In some more embodiments, control circuitries 220 and/or control circuitry 218 are configured for monitoring user interaction with a post on social media and determining whether the interaction is a positive or negative interaction and based on the type of interaction, i.e., positive, or negative, enhancing search results for a search query entered in a search engine (such as Google, Yahoo, Bing, etc.) by integrating social media insights, receiving search queries on a search engine, when a search query is entered, if a topic of the search query matches a social media post with which the user may have interacted, then integrating social media insights into external application search results, such as mapping or review platforms, to enhance the relevance and personalization of search results by including posts from social media users. In yet other embodiments, control circuitries 220 and/or control circuitry 218 are configured for facilitating reposting of posts that a user has interacted with on the social media application via their social media account, such as by providing a one-click reposting feature along with an automated tracking system that compiles and summarizes user interactions with a plurality of posts to generate dynamic content summaries that capture the nature and depth of the user interaction, dynamically generating curated content summaries, making the summaries and the posts associated with the summaries available for easy reposting using the single button click feature. In yet other embodiments, control circuitries 220 and/or control circuitry 218 are configured for providing a cross-platform reposting feature that allows users to share selected content from one social media platform to another, categorizing posts automatically based on their content type, utilizing natural language processing and image recognition technologies to analyze the content of each post and classifying it, and automatically cross posting to one or more social media platforms based on the post's categorization. In yet other embodiments, control circuitries 220 and/or control circuitry 218 are configured for utilizing NLP, AI, and ML engines to execute associated algorithms for determining various solutions described herein, and performing functions related to all other processes and features described herein.

Computing device 218 receives a user input 204 at input circuitry 216. For example, computing device 218 may receive data relating to a user interaction with a social media post. Transmission of user input 204 to computing device 218 may be accomplished using a wired connection, such as an audio cable, USB cable, ethernet cable or the like attached to a corresponding input port at a local device, or may be accomplished using a wireless connection, such as Bluetooth, WIFI, WiMAX, GSM, UTMS, CDMA, TDMA, 3G, 4G, 4G LTE, or any other suitable wireless transmission protocol. Input circuitry 216 may comprise a physical input port such as a 3.5 mm audio jack, RCA audio jack, USB port, ethernet port, or any other suitable connection for receiving audio over a wired connection or may comprise a wireless receiver configured to receive data via Bluetooth, WIFI, WiMAX, GSM, UTMS, CDMA, TDMA, 3G, 4G, 4G LTE, or other wireless transmission protocols.

Processing circuitry 240 may receive input 204 from input circuit 216. Processing circuitry 240 may convert or translate the received user input 204 that may be in the form of voice input into a microphone, or movement or gestures to digital signals. In some embodiments, input circuit 216 performs the translation to digital signals. In some embodiments, processing circuitry 240 (or processing circuitry 226, as the case may be) carries out disclosed processes and methods. For example, processing circuitry 240 or processing circuitry 226 may perform processes as described in 1A-1C, and 4-21, respectively.

FIG. 3 is a block diagram of an electronic device used for performing the disclosed embodiments, in accordance with some embodiments of the disclosure. FIG. 3 can also be used for using a social media application, OTT service provider application, and a search application. In an embodiment, the equipment device 300, is the same equipment device 202 of FIG. 2. The equipment device 300 may receive content and data via input/output (I/O) path 302. The I/O path 302 may provide audio content. The control circuitry 304 may be used to send and receive commands, requests, and other suitable data using the I/O path 302. The I/O path 302 may connect the control circuitry 304 (and specifically the processing circuitry 306) to one or more communications paths or links (e.g., via a network interface), any one or more of which may be wired or wireless in nature. Messages and information described herein as being received by the equipment device 300 may be received via such wired or wireless communication paths. I/O functions may be provided by one or more of these communications paths or intermediary nodes but are shown as a single path in FIG. 3 to avoid overcomplicating the drawing.

The control circuitry 304 may be based on any suitable processing circuitry such as the processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 or i9 processor).

In client-server-based embodiments, the control circuitry 304 may include communications circuitry suitable for monitoring user consumption history on a first application, such as an OTT application, analyzing the monitored user consumption to determine user preferences, and based on the monitoring and analysis, selecting an image or video that is aligned with the determined user preferences, and posting the selected image or video on a second application, e.g., a social media application, that is distinct from the first application, such that when a user logs in to their social media account, the image or video that is aligned with their preferences determined at the first application is displayed to the user. In yet other client-server-based embodiments, the control circuitry 304 may include communications circuitry suitable for monitoring user interaction with a post on social media application and determining whether the interaction is a positive or negative interaction, performing an action on a different application, e.g., an OTT application that is distinct from the social media application on which the interaction with the post took place, based on the determined type of interaction, configuring a screen saver or a wallpaper on the OTT application for the user's account such that when the user logs in using their account to the OTT application, displaying on the OTT application, a screen saver or a wallpaper having the same image or video clip as the post with which the user engaged positively in the social media application, configuring one or more media asset recommendations that are related to the post on the OTT application for the user's account such that when the user logs in using their account to the OTT application, the recommendations of media assets that are related to the post with which the user engaged positively in the social media application are displayed on the OTT application. In yet other client-server-based embodiments, the control circuitry 304 may include communications circuitry suitable for monitoring user interaction with a post on social media and determining whether the interaction is a positive or negative interaction and based on the type of interaction, i.e., positive, or negative, enhancing search results for a search query entered in a search engine (such as Google, Yahoo, Bing, etc.) by integrating social media insights, receiving search queries on a search engine, when a search query is entered, if a topic of the search query matches a social media post with which the user may have interacted, then integrating social media insights into external application search results, such as mapping or review platforms, to enhance the relevance and personalization of search results by including posts from social media users. In yet other client-server-based embodiments, the control circuitry 304 may include communications circuitry suitable for facilitating reposting of posts that a user has interacted with on the social media application via their social media account, such as by providing a one-click reposting feature along with an automated tracking system that compiles and summarizes user interactions with a plurality of posts to generate dynamic content summaries that capture the nature and depth of the user interaction, dynamically generating curated content summaries, making the summaries and the posts associated with the summaries available for easy reposting using the single button click feature. In yet other client-server-based embodiments, the control circuitry 304 may include communications circuitry suitable for providing a cross-platform reposting feature that allows users to share selected content from one social media platform to another, categorizing posts automatically based on their content type, utilizing natural language processing and image recognition technologies to analyze the content of each post and classifying it, and automatically cross posting to one or more social media platforms based on the post's categorization. In yet other client-server-based embodiments, the control circuitry 304 may include communications circuitry suitable for utilizing NLP, AI, and ML engines to execute associated algorithms for determining various solutions described herein, and performing functions related to all other processes and features described herein.

The instructions for carrying out the above-mentioned functionality may be stored on one or more servers. Communications circuitry may include a cable modem, an integrated service digital network (ISDN) modem, a digital subscriber line (DSL) modem, a telephone modem, ethernet card, or a wireless modem for communications with other equipment, or any other suitable communications circuitry. Such communications may involve the internet or any other suitable communications networks or paths. In addition, communications circuitry may include circuitry that enables peer-to-peer communication of primary equipment devices, or communication of primary equipment devices in locations remote from each other (described in more detail below).

Memory may be an electronic storage device provided as the storage 308 that is part of the control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid-state devices, quantum-storage devices, or any other suitable fixed or removable storage devices, and/or any combination of the same. The storage 308 may be used to store various types of content, (e.g., user interaction/engagement with posts, types of engagement and engagement metrics associated with each interaction/engagement with the posts, links associated with each post, generated and curated summaries for user interacted social media posts, user preferences, such as in types of genre, user selection of activation options, wallpapers and screensavers for displaying on OTT applications associated with user account, user ID, post ID, association of each post with a function to be performed, mapping of search results with social media posts with which the user interaction, both positive and negative engagement details, user account details associated with different social media applications, and NLP, AI and ML algorithms). Cloud-based storage, described in relation to FIG. 3, may be used to supplement the storage 308 or instead of the storage 308.

The control circuitry 304 may include audio generating circuitry and tuning circuitry, such as one or more analog tuners, audio generation circuitry, filters or any other suitable tuning or audio circuits or combinations of such circuits. The control circuitry 304 may also include scaler circuitry for upconverting and down converting content into the preferred output format of the electronic device 300. The control circuitry 304 may also include digital-to-analog converter circuitry and analog-to-digital converter circuitry for converting between digital and analog signals. The tuning and encoding circuitry may be used by the electronic device 300 to receive and to display, to play, or to record content. The circuitry described herein, including, for example, the tuning, audio generating, encoding, decoding, encrypting, decrypting, scaler, and analog/digital circuitry, may be implemented using software running on one or more general purpose or specialized processors. If the storage 308 is provided as a separate device from the electronic device 300, the tuning and encoding circuitry (including multiple tuners) may be associated with the storage 308.

The user may utter instructions to the control circuitry 304, which are received by the microphone 316. The microphone 316 may be any microphone (or microphones) capable of detecting human speech. The microphone 316 is connected to the processing circuitry 306 to transmit detected voice commands and other speech thereto for processing. In some embodiments, voice assistants (e.g., Siri, Alexa, Google Home and similar such voice assistants) receive and process the voice commands and other speech.

The electronic device 300 may include an interface 310. The interface 310 may be any suitable user interface, such as a remote control, mouse, trackball, keypad, keyboard, touchscreen, touchpad, stylus input, joystick, or other user input interfaces. A display 312 may be provided as a stand-alone device or integrated with other elements of the electronic device 300. For example, the display 312 may be a touchscreen or touch-sensitive display. In such circumstances, the interface 310 may be integrated with or combined with the microphone 316. When the interface 310 is configured with a screen, such a screen may be one or more monitors, a television, a liquid crystal display (LCD) for a mobile device, active-matrix display, cathode-ray tube display, light-emitting diode display, organic light-emitting diode display, quantum-dot display, or any other suitable equipment for displaying visual images. In some embodiments, the interface 310 may be HDTV-capable. In some embodiments, the display 312 may be a 3D display. The speaker (or speakers) 314 may be provided as integrated with other elements of electronic device 300 or may be a stand-alone unit. In some embodiments, the display 312 may be outputted through speaker 314.

The equipment device 300 of FIG. 3 can be implemented in system 200 of FIG. 2 as primary equipment device 202, but any other type of user equipment suitable for allowing communications between two separate user devices for performing the functions related to implementing machine learning (ML) and artificial intelligence (AI) algorithms, and all the functionalities discussed associated with the figures mentioned in this application.

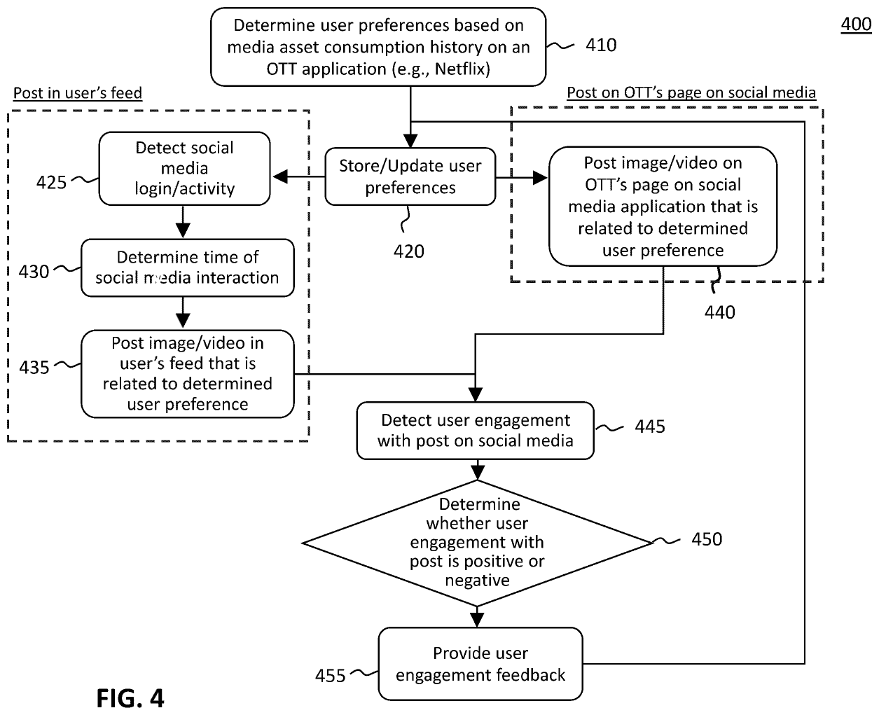

FIG. 4 is a flowchart of a process 400 for selecting images and clips from a media asset, based on a user's consumption history of media assets on an OTT application, and posting them on a social media platform for the user's consumption, in accordance with some embodiments of the disclosure. The process 400 may be implemented, in whole or in part, by systems or devices such as those shown in FIGS. 2-3. One or more actions of the process 400 may be incorporated into or combined with one or more actions of any other process or embodiments described herein. The process 400 may be saved to a memory or storage (e.g., any one of those depicted in FIGS. 2-3) as one or more instructions or routines that may be executed by a corresponding device or system to implement the process 400.

In some embodiments, user's preferences may be determined at block 410, based on the user's consumption history of media assets using the user's account on an OTT application, such as Netflix, Hulu, Disney, Amazon, Apple, ESPN, and others. In some embodiments, a determination may be made as to what a user typically watches between certain hours, on weekday mornings, weekday afternoons, weekday evenings, weekend mornings, weekend afternoons, weekend evenings, and on holidays and special occasions, such as anniversaries, birthdays, etc. For example, as depicted in FIG. 6, user 1 may, on average (or by other calculations, such as standard deviation, mean, etc.), enjoy comedy more than other genres. In another example, user 2 may, on average (or by other calculations, such as standard deviation, mean, etc.), enjoy romance more than other genres. Even within the genres user 1 may prefer a specific type of action, director, or style of movie. User 1 may further prefer movies with certain ratings or those that are rated for parental guidance.

At block 420, the control circuitry 220 and/or 228 may store the user preferences, determined at block 410, in a database associated with the OTT application. For example, the OTT application may save user 1's preferences as likes comedy, likes actors 1 and 2, likes director 1, likes to watch comedy during the hours of 6:00-9:00 p.m. on weeknights and does not like media assets with horror as a genre.

Once the user preferences are stored at block 420, the OTT service provider may want to post an image or video clip of the movie “The Wedding Planner,” as it may be a movie the OTT service provider is currently promoting. Since user 1 enjoys comedy more than other genres, a scene from “The Wedding Planner” that is associated with comedy may be displayed in the posting, at block 440, on social media by the OTT service provider. Accordingly, in some embodiments, the OTT service provider may analyze all the scenes in the movie “The Wedding Planner” (no shown in figure) and determine which scenes are associated with comedy. Such a determination may be made based on comments received from other users, metadata inputted by the directors and producers of the movie, or by using artificial intelligence, including leveraging a large language model (LLM). Once the determination is made, the starting play position may be placed at the start of the selected comedy scene and then posted, at block 440, by the OTT service provider on a social media platform (such as Facebook) specifically for user 1's consumption, i.e., associated with user 1's social media account. Likewise, since user 2 enjoys romance more than other genres, a scene from the same movie, “The Wedding Planner,” that is associated with romance may be posted on a social media platform and associated with user 2's account such that only user 2 may be able to see the romance scene. As such, two different scenes from the same movie may be selected, each based on the user's preferences learned from their consumption of media assets on a different application, i.e., the OTT application. When the two different selected scenes are posted on social media, they may each be associated with the respective user's account such that only the user for whom the selected scene is targeted may be able to consume the selected scene. In other words, user 1 may see only the comedy scene for “The Wedding Planner,” and user 2 may see only the romantic scene.

In some embodiments, the posting may be made 1) in the user's feed on the social media application, and in other embodiments, the posting may be made on 2) an OTT service provider's page on the social media application. Blocks 425-435 refer to posting in the user's feed on the social media application, and block 440 refers to posting on an OTT service provider page on the social media application.

At block 425, in some embodiments, social media activity, such as login by the user, may be detected. In other embodiments, it may not be necessary to detect the social media activity by the user, and the social media application may simply make the post in the user's feed such that whenever the user logs in or is active, they are able to consume the post made by the OTT service provider.

At block 430, a determination of the time the user is likely to interact with the post on the social media interaction may be made. The determination of time may be used to evaluate whether the user, based on the user's preferences as to time determined at block 410, would be interested in the genre of this selected scene. For example, if the same user enjoys comedy in the evenings but enjoys action or motivational genres in the morning, then the time of interaction with the post may be relevant in order to place the scene that is most appropriate based on the user's preferences. For example, if the user is interacting with the post in the morning, then a different scene from the same movie that relates to action or motivation may be posted, and if the user is interacting with post in the evening, then a different scene from the same movie that relates to comedy may be posted. The post may then be made in the user's feed accordingly at block 435.

Although blocks 425 and 430 may allow selection and posting of the image or clip by the OTT service provider that is more granular based on time of interaction with the post, in another embodiment, the image or scene may be posted without having to determine the time of interaction with the post. In other words, the posting at block 435 may be made such that whenever the user interacts with the post in their feed, they will see a scene that is based on their overall preference, determined through consumption of media assets on the OTT application.

Referring to block 440, where the posting is made on an OTT service provider page on the social media application, the posting may be made at any time, or may have time specific instructions to determine the user's preferences based on the time the user navigates to the OTT service provider page.

At block 445, regardless of where the post is made (e.g., in the user's feed, on the OTT service provider's page on the social media platform, or as an advertisement, or in the sponsored section), the control circuitry may detect the users engagement with the post.

At block 450, a determination may be made whether the user engagement with the post is a positive or negative engagement. If the user likes or shares the post, among other user actions performed, such engagement may be determined to be a positive engagement, and the opposite, when the user dislikes or scrolls away, may be determined to be a negative engagement.

At block 455, the user engagement feedback maybe provided to the OTT service provider such that the user preferences may be updated and stored in the user's profile for subsequent determinations of selecting a scene for posting in the social media application for the user's account. The user engagement feedback may include details relating to the type of engagement by the user with the post, such as referred to in FIG. 15, the duration of the engagement, and both positive and negative metrics associated with the user engagement.

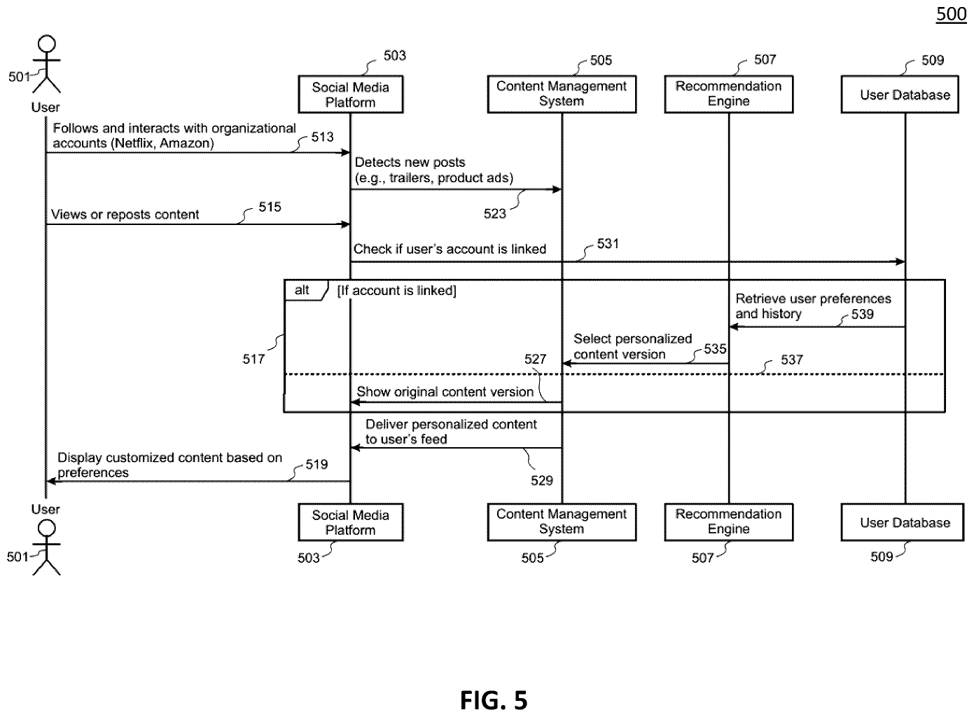

FIG. 5 is a flowchart of a process 500 for displaying customized content on a social media application based on a user's preferences determined from user consumption history on an OTT application, in accordance with some embodiments of the disclosure.

The process 500 may be implemented, in whole or in part, by systems or devices such as those shown in FIGS. 2-3. One or more actions of the process 500 may be incorporated into or combined with one or more actions of any other process or embodiments described herein. The process 500 may be saved to a memory or storage (e.g., any one of those depicted in FIGS. 2-3) as one or more instructions or routines that may be executed by a corresponding device or system to implement the process 500.

In some embodiments, process 500 may be used to integrate social media engagement of organizations (e.g., OTT service providers) with personalized content delivery to enhance user experience based on individual preferences and user status with various services. This embodiment is applicable to a range of organizations such as OTT service providers like Netflix and e-commerce platforms like Amazon, focusing on how these organizations' social media posts about their content, products, or services can lead to personalized interactions when these posts are shared or reposted by users. The system is configured to detect when an organization like Netflix or Amazon posts new content, such as teasers, trailers, product advertisements, or special offers, on its social media channels. When a user who follows these organizations' accounts views or reposts this content, the system triggers a dynamic content adjustment for that post when it first appears to the user or when it appears in the feeds of other users who also follow these organizations and have their accounts linked. For example, if a user follows the social media account of Netflix and does not have their Netflix account linked or shared with the social media network, the user may see the original post (and teaser, product post, etc.). However, if the user has their account shared or linked, they may see a modified version of the content that matches their recommendation profile.

For example, for an OTT provider such as Netflix, this could involve showing different versions of a movie trailer based on the viewer's past viewing preferences stored in Netflix's recommendation engine. For Amazon, this might involve highlighting specific features of a product or promotional offers based on the viewing and purchasing history of the users viewing the post. For example, if Netflix posts a trailer for a new romantic comedy film and a user consumes the post or reposts this trailer, the system could display a version of the trailer that emphasizes romantic elements to one user and comedic elements to another, depending on their viewing history. When users who do not share their account or are not Netflix subscribers view the post, it may be the original version posted by the Netflix social media account. Similarly, if Amazon posts about a new technological gadget and it is reposted, the system could show a version highlighting technical specifications to a user interested in tech details and a version emphasizing ease of use to a non-tech-savvy user.

The system processes involve querying the respective databases of Netflix or Amazon to retrieve user preferences and history for users who are about to view the reposted content. Based on this data, the system selects which version of the content to display—customizing it to suit the viewer's known preferences or past behavior. This tailored content is dynamically inserted into the social media feed in real time, ensuring that each user receives content that is most likely to appeal to their interests and increase engagement. It should be noted that the alternative versions of the media content may be created by the original social media account (for example by Netflix or Amazon), by allowing followers who have linked or shared their accounts to manually modify the content (for example by providing snippets and allowing users to compose “new” versions including overlaying text, images, etc.), or through the use of generative AI and ML.

In some cases, the system enables a pre-loading mechanism where Netflix, or a similar content provider, uploads recommended variations of posts to the social media network in advance. This method involves Netflix sending a set of content variations tailored to different user preferences and profiles directly to the social media platform. The selection of which specific version of the content to display to an individual user then occurs within the social media network, based on real-time analysis of the user's profile data available to the network. Along with the post text and content (“the post”), the posting account (or their system) may include metadata that describes the intended target audience for each version of the post they are uploading. This metadata could include information such as preferred genres, demographic data, past engagement metrics, and other relevant user profile characteristics.

Referring to the steps displayed in FIG. 5, in some embodiments, the process 500 may be initiated at step 513 when a user 501 follows and interacts with an OTT service provider account on a social media platform 503. In other words, if the user navigates to the OTT service provider's page on the social media application, such as to Netflix's page on a Facebook or X application or interacts with a post by Netflix on their social media feed.

If an interaction is detected by the social media platform, such as the user following Netflix or navigating to their page (or that a Netflix post is posted on the user's feed), the social media platform at 523 communicates with content management system 505 to detect which posts (e.g., trailers, videos, images, product ads) are to be displayed to the user 501.

The social media platform at 531 checks with the user database 509 to determine if the user's account is linked with the organization that posted the video, scene, or trailer, such as the OTT service provider. Similarly, if the social media platform 503 detects views or reposts of content by the user at 515, it checks with the user database 509 to determine if the user's account is linked with the organization that posted the video, scene, or trailer, e.g., Netflix.

If a determination is made at 517 that the user's social media account is linked with the OTT service provider account, then at 539 user preferences and history is retrieved from the user database. Based on the retrieved user preferences and history, personalized contact is selected at 535. As described earlier, in one example, based on users consumption history on Netflix, if a determination is made that the user prefers comedy at 539, then a comedy scene from a movie is selected and posted for the user's consumption on the social media platform.

Once personalized content is selected at 535, it is delivered to the social media platform for displaying in the user's feed at 529. In some embodiments, both the original content version 527 and the personalized content version may be delivered to the social media platform. The social media platform 503 may then at 519 display customized content based on the preferences to the user 501. For example, as depicted in FIG. 6, based on a determination that user 1 enjoys comedy, a comedy scene from the movie wedding planner may be selected and displayed in user 1's social media feed (as depicted at 630 in FIG. 6).

FIG. 6 is a block diagram of an example of using a user's consumption history from an OTT application to select and post images and clips on a social media application, in accordance with some embodiments of the disclosure. In some embodiments, users 1 and 2 may each have an account on the OTT application, such as Netflix, as well as an account on a social media application, such as X (formerly Twitter) or Facebook. In some embodiments, at 610, user 1 may have logged in to their account associated with the OTT application and consumed movie 1, which is related to comedy; movie 2, which is related to action; sitcom 1, which is related to comedy; episode 1 of a series that is related to horror; sitcom 2, which is related to comedy; and a standup comedy show that is related to comedy. Accordingly, of the six media assets consumed, user 1 may have consumed four media assets that relate to comedy. As such, a determination may be made that on an average user 1 likes to consume comedy more than horror or action. Likewise, as depicted also at block 610, user 2 may have logged in to their account associated with the OTT application and consumed episode 1, which is related to romance; episode 2, which is related to romance; docuseries 1, which is related to education; movie 1, which is related to romance; and speech 1, which is related to sports.

The media asset consumption histories related to user 1 and user 2 may then be analyzed by the OTT server, such as the Netflix server 620. The analysis may determine, based on the total number and type of media assets consumed by each user, that particular genres are of more interest to users 1 and 2 than other genres. In some embodiments, the server may also make such a determination based on the most recently consumed media assets, such as media assets consumed within the past day, week, month, or some other predetermined interval.

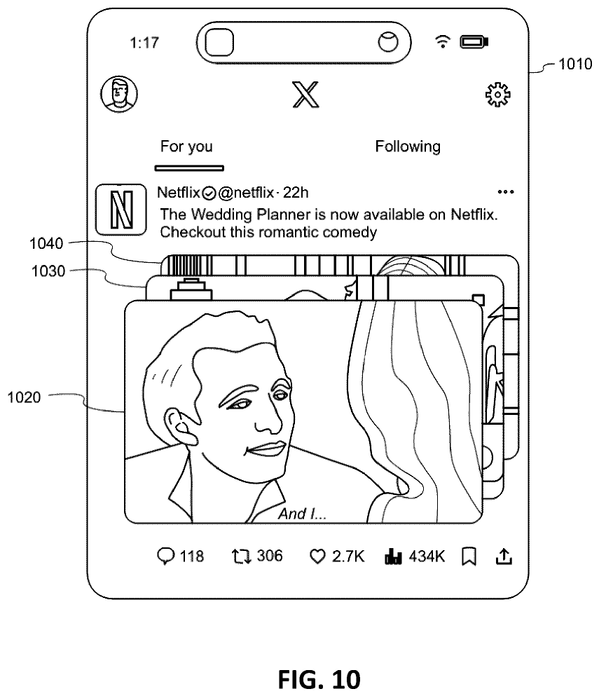

In some embodiments, after a determination has been made that user 1 prefers comedy and user 2 prefers romance, the Netflix server may provide instructions to a social media server associated with the social media application to post, on a feed associated with the user 1's account (or on an OTT service provider's page that is visible to user 1 based on their account), a selected image or clip of a comedy scene from a movie, “The Wedding Planner.” As depicted at 630, the social media server may then post the selected comedy image or clip on the social media application for the user 1 account. Likewise, after a determination has been made that user 2 prefers romance, the Netflix server may provide instructions to a social media server associated with the social media application to post on a feed associated with user 2's account (or on an OTT service provider's page that is visible to the user based on their account), a selected image or clip of a romantic scene from the same movie, i.e., “The Wedding Planner. As depicted at 640, the social media server may then post the selected romance image or clip on the social media application for the user 2 account. Although a single scene, clip, image, or video is discussed above, the OTT service provider may also post a stack or multiple scenes, clips, images, or videos based on the determined user's preferences. Additional details on posting multiple scenes, clips, images, or videos are described in the description of FIG. 10.

Since the user's preferences may changes over time, such as preferences of users 1 and 2 in 610, the selection process of selecting images, clips, videos, and displaying them at 630 and 640 may be dynamic and can be adjusted in real-time as more data about the user's interactions and preferences is collected. For instance, if a user starts showing an increased interest in a certain genre, the system may adapt by choosing versions aligned with this new interest in subsequent posts.

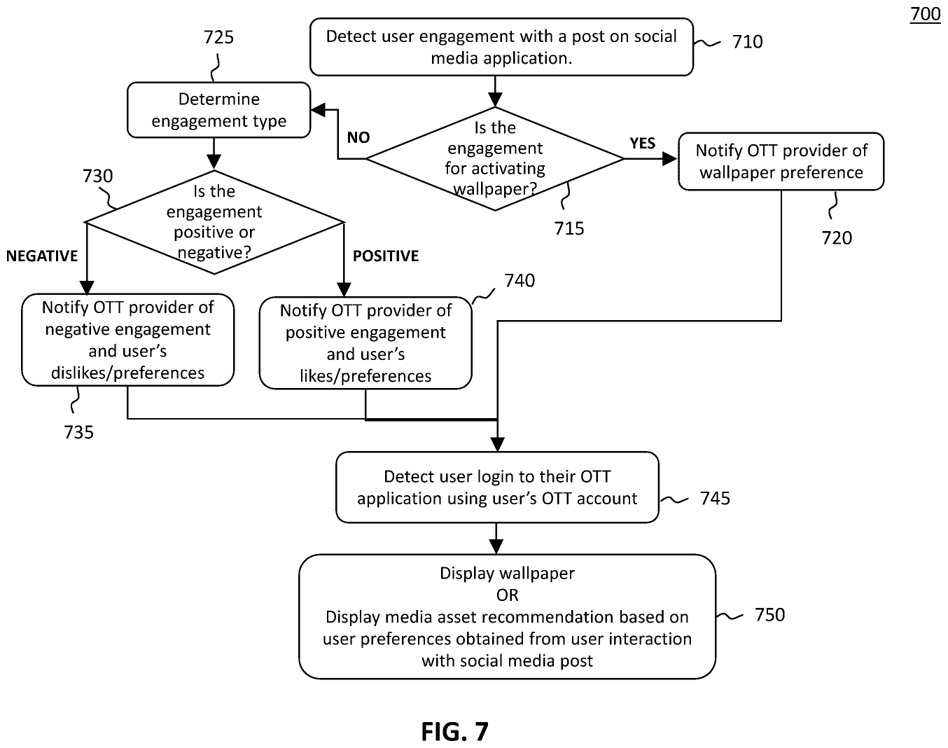

FIG. 7 is a flowchart of a process 700 for configuring an OTT application for a user based on the user's engagement with a post on a social media application, in accordance with some embodiments of the disclosure. Process 700 may be used for recommending media assets to a specific user or configuring a screen saver or a wallpaper for the specific user on their OTT application based on the user's engagement with a post on a social media application. The process 700 may be implemented, in whole or in part, by systems or devices such as those shown in FIGS. 2-3. One or more actions of the process 700 may be incorporated into or combined with one or more actions of any other process or embodiments described herein. The process 700 may be saved to a memory or storage (e.g., any one of those depicted in FIGS. 2-3) as one or more instructions or routines that may be executed by a corresponding device or system to implement the process 700.

In some embodiments, the process may begin at block 710, where user engagement with a post on a social media application may be detected. In some embodiments, the post may be made by an OTT service provider, and in other embodiments, the post may be made by someone else other than the OTT service provider. When the post is made by the OTT service provider, it may be mapped on the OTT service provider's end to an action that is to be configured on the user's account associated with the OTT application. When the post is not made by the OTT service provider, then details associated with the post may be provided to the OTT service provider to determine whether the post is related to a media asset offered by the OTT service provider.

At block 715, a determination may be made whether the user engagement with the social media post relates to activating a wallpaper or screen saver on the user's account associated with the OTT application. In some embodiments, the OTT service provider may instruct the social media server to configure the post such that when the post is selected, it displays an activation option, or some other means of activation, that when selected by the user may transmit selection of the option to the OTT service provider. The OOT service provider may then use the received information relating to the selection of the activation option and activate a wallpaper or screen saver on the user's account associated with the OTT application.

If a determination is made, at block 715, that the user engagement with the post is not for activating a wallpaper (or a screen saver {not depicted in figure}) on the OTT application, then, at block 725, the type of engagement may be determined. At block 730, a determination may be made whether the type of engagement is it positive or negative engagement or exceeds a threshold score. If a determination is made that the engagement is a positive engagement, then the OTT service provider may be provided details and engagement metrics associated with the positive engagement. Likewise, if a determination is made that the engagement is a negative engagement, then the OTT provider may be informed of details associated with the negative engagement. Both positive and negative engagements and associated engagement metrics may be used to determine the user's likes and dislikes, and such preferences may be taken into account by the OTT server in recommending media assets. The user's preferences may also be stored in a database associated with the OTT application such that future recommendations for media assets may consider such preferences in making its recommendations.

Referring back to block 715, if a determination is made that the user engagement with the post is for activating wallpaper or a screen saver, then at block 720, the OTT service provider may be notified of the user's preference to display a screen saver or wallpaper on the user account associated with the OTT application, such as user 1's Netflix account. The determination that the user engagement with the post relates to activating wallpaper or screen saver on the OTT application may be made when, in some embodiments, the user selects an activation option displayed in the vicinity of the post.

In some embodiments, at block 745, a detection may be made that the user has logged in to their OTT application using their OTT account. As such, at block 750, the OTT server may display a screen saver or wallpaper, if such was the purpose, determined at block 715, of the engagement, or it may display recommendations for media assets that are based on user preferences obtained from the user interaction with the social media post.

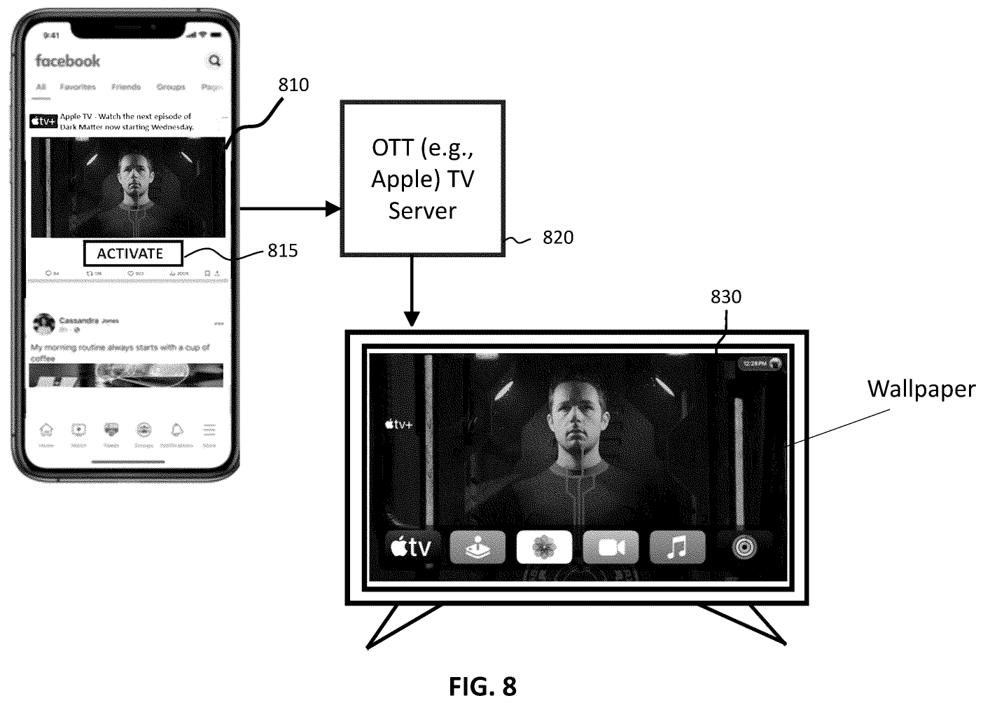

An example of activating a wallpaper or screen saver is depicted in FIG. 8, in accordance with some embodiments of the disclosure. As depicted, in one embodiment, a user may log in to their social media account and engage with a post made by the OTT service provider. In doing so, the user may select an activate button 815 associated with the post 810. The activation button may be in several forms, such as a button or hyperlink, or the image itself may be selectable to display an activation option.

When the activation option, such as in the form of a button, an icon, or deep linked text, is selected by the user or invoked in some other manner (e.g., automatically), the user ID and the post ID may be transmitted from the social media server associated with the social media application to the OTT server, such as an Apple TV server. As an example, the user, having logged in to their account on Facebook, may have selected the activation button 815 for the image of a series, “Dark Matter” 810. As such, the user ID and the post ID associated with the “Dark Matter” image may be sent to the Apple TV server 820.

The Apple TV server 820 may receive the user ID and the post ID and associate them with the user wanting to install or activate a screen saver or a wallpaper on their account associated with Apple TV. In some embodiments, since it may be the OTT service provider (such as Apple TV) posting the social media application, the OTT service provider may maintain a list of posts made, their post IDs, and a mapping of the post IDs to an action that is to be taken on the OTT application by the OTT service provider. For example, in one embodiment, a post ID for “Dark Matter” may be maintained by the OTT service provider, and an action associated with the post ID may be to configure a wallpaper or screen saver on a user account when positive engagement information is received from the social media server. In another embodiment, the post ID for “Dark Matter” may be maintained by the OTT service provider, and an action associated with the post ID may be to configure a wallpaper or screen saver on the user account if the user selects a wallpaper or screen saver activation option provided with the post on the social media application. As such, the OTT server, as depicted at 830, may configure the screen saver or wallpaper on the user's account associated with Apple TV such that whenever the user logs in to Apple TV using their account, the screen saver or wallpaper may automatically appear (e.g., wallpaper of “Dark Matter” displayed on the user account associated with Apple TV, which is same as the image activated by the user on Facebook). The OTT server may provide various customizations to the wallpaper or screen saver. For example, the OTT server may allow the user to have the wallpaper or screen saver appear at all times, or at certain times, on the user's home screen associated with their OTT account on Apple TV. The OTT server may also recommend other wallpapers from the same media asset and rotate the wallpapers from time to time when the user logs in.

An example of recommending one or more media assets is depicted in FIG. 9, in accordance with some embodiments of the disclosure. In one embodiment, a user may log in to their social media account and engage with a post made by the OTT service provider. In doing so, the user may engage with the post in a positive or a negative manner or in a manner that exceeds a threshold score (e.g., for a longer duration, etc.). Some examples of positive engagement may include the user liking the post, hovering over the post, gazing at the post, spending at least a threshold amount of time looking at the post, or sharing the post. Some examples of negative engagement may include the user disliking the post or scrolling away or moving on from the post without spending a threshold amount of time on it.

In one example, the OTT service provider may post an image of the actress Keira Knightley, as depicted at 910, on the social media platform. As described previously, in some embodiments, the image or clip posted may not directly refer to any media asset. It may be general information about the actress or something about her personal or professional life. However, in other embodiments, it may refer to a media asset.

If the user interacts with the posted image, whether positively or negatively, such engagement information, which includes the user ID of the user that engaged with the post, the post ID of the image, and related metrics may be provided by the social media server to the OTT server 920. In some embodiments, since it may be the OTT service provider (such as Netflix) posting on the social media application (e.g., social media server automatically posting or an employee of the social media provider doing the posting), the OTT service provider may maintain a mapping of the post ID related to the Keira Knightley image and associate it with an action to recommend media assets related to Keira Knightley.

The OTT server may utilize its recommendation engine to analyze the received user engagement data with the post on social media. If a determination is made that the user engaged with the post 910 in a positive manner, then attributes of the post may be used to query a database that includes a plurality of media assets. A selection may be made by the recommendation engine to one or more media assets that include the same attribute as the attribute in the posted image. In some embodiments, if a plurality of attributes appear in the posted image, then an artificial intelligence (AI) engine, such as an LLM, may be leveraged to select the most relevant attribute to the user (e.g., based on the user's consumption history), and then such attribute may be used to search for and recommend media assets.

In one example, since the user engaged with the Keira Knightley image posted on their account on the Facebook application at 910, the OTT server 920 may search for media assets that are provided by the OTT service provider that also include Keira Knightley. In one example, the movie “Imitation Game,” which includes the actress Keira Knightley, may then be displayed, such as on a landing page, on the OTT application associated with the user account, as depicted at 930. The movie “Imitation Game” or other movies that are recommended to the user based on the user's interaction with a related post may be visually distinguished with other recommendations made to the user. For example, the movie “Imitation Game” may be highlighted, shaded, colored in a different color, circled, or visually distinguished in some other manner making it more prominent that other recommendations. It may, in some embodiments, also include an overlay of the social media platform icon, such as a Facebook icon, where the user first interacted with a related post. The user's interaction data that is associated with a specific post can therefore by used by various services associated with an external application. For example, a recommendation service associated with an OTT service may use the interaction data to recommend a movie or adjust a recommendation score of another movie. The interaction data with the post may indicate a dislike or a disinterest in the topic of the post (e.g., based on user's explicit or implicit interaction data), which may result in not recommending a movie or content that feature that person or topic in the post.

Although FIGS. 8 and 9 refer to the OTT service provider causing the post to be made on the social media application, the embodiments are not so limited. As described earlier, the post may be made by someone else other than the OTT service provider. However, in the scenario where someone else posts the image or clip on social media platform, a post ID may not be known, and its associated action may not be predetermined by the OTT service provider. The OTT service provider, in this scenario, may obtain metadata associated with the post from the social media application and may perform additional analysis to determine whether metadata from the post, with which the user has positively engaged, can be associated/matched with a media asset offered by the OTT service provider. If so, the OTT service provider may utilize its recommendation engine 925 to provide a recommendation on the landing page, or some other page, of the OTT application associated with the user account that relates to the metadata and any attribute of the image on the social media post engaged with by the user.

FIG. 10 is an example of recommending multiple media assets on an OTT application's use interface based on user engagement with a post on a social media application, in accordance with some embodiments of the disclosure. In some embodiments, the OTT service provider may analyze the user's consumption history, such as the user consumption history of user 1 at 610 and determine a primary and a secondary user preference. For example, a determination may be made that the user primarily likes comedy but also likes action, and romantic movies. Accordingly, multiple images or clips associated with comedy, action, and romance for the same movie, “The Wedding Planner,” may be posted in a stacked order on a social media application associated with the user's account. In this embodiment, the stacking of images 1020, 1030, and 1040, posted on the social media application 1010, may reflect the order of the user's preference. In other words, the highest preference (such as comedy) 1020 may be display on top of the stack and the lowest preference at the bottom of the stack. As such, a scene, image, video of the highest preferred genre may be displayed at the front or top of the stack making it most visible and the remaining secondary preferences may be stacked behind it. In another embodiment, the scene, image, video of the highest preferred genre may be displayed more prominently than other scenes or image from lower preferred genres. In yet another embodiment, the scene, image, video of the highest preferred genre may be highlighted, colored, shaded, displayed with a border to distinguish it from other scenes or image from lower preferred genres.

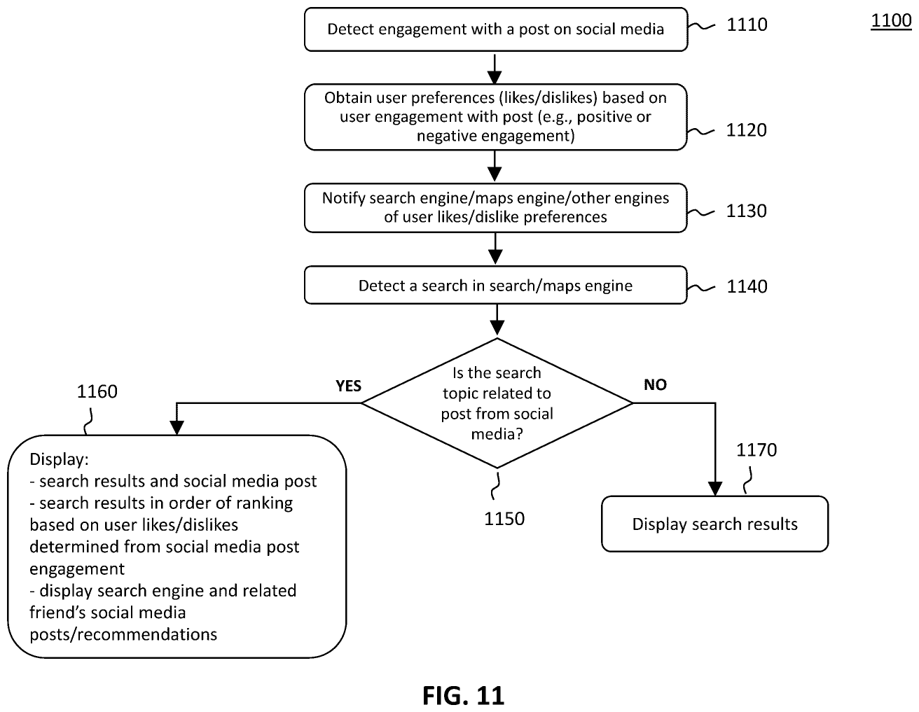

FIG. 11 is a block diagram of a process 1100 for enhancing search results for a query entered into a search engine based on user engagement with a post on a social media application, in accordance with some embodiments of the disclosure. The process 1100 may be implemented, in whole or in part, by systems or devices such as those shown in FIGS. 2-3. One or more actions of the process 1100 may be incorporated into or combined with one or more actions of any other process or embodiments described herein. The process 1100 may be saved to a memory or storage (e.g., any one of those depicted in FIGS. 2-3) as one or more instructions or routines that may be executed by a corresponding device or system to implement the process 1100.

In some embodiments, at block 1110, user engagement with a post may be detected. The post may be made by anyone, such as by someone in the user's friends circle on Facebook or another user or entity that the user follows on X (formerly Twitter).

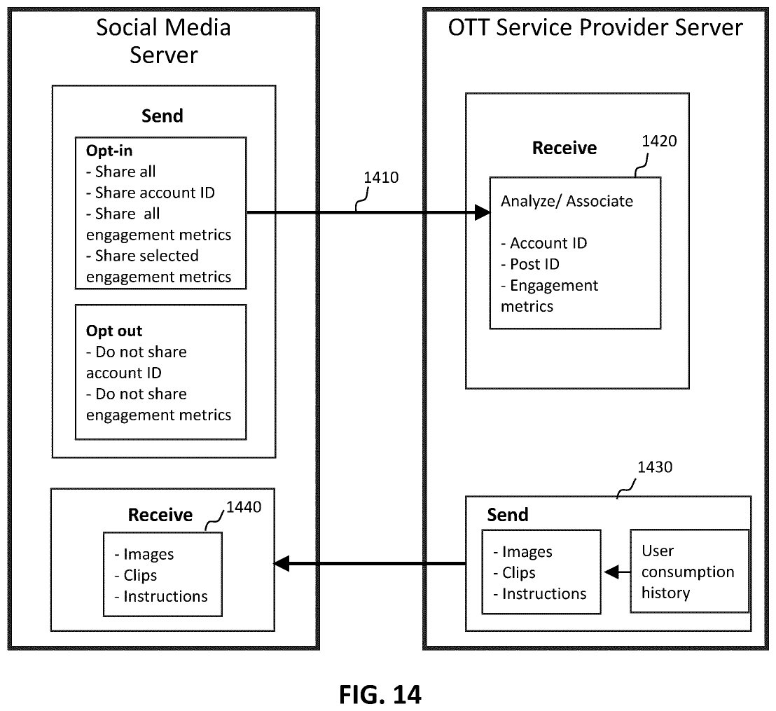

At block 1120, user preferences, such as user likes and dislikes, based on user engagement with the social media post may be obtained. The user preferences may be obtained based on determining whether the type of user engagement with the post on the social media application on the user's account is it positive or negative engagement. If a determination is made that the engagement is a positive engagement, then, the search engines previously used by the user may be notified of the details and engagement metrics associated with the positive engagement. Likewise, if a determination is made that the engagement is a negative engagement, then the search engines previously used by the user, may be notified of the details and engagement metrics associated with the negative engagement. Some examples of search engines previously used by the user may include Google, Yahoo, Bing, including maps search engines such as Google Maps, Apple Maps, MapQuest, Bing Maps, Waze, and other types of category-specific search engines, such as search engines that allow search of restaurants (e.g., Yelp), travel (e.g., Expedia, Kayak, Priceline, Google Travel), products (e.g., Amazon, Walmart, Best Buy, Target), and other services (e.g., search engines that find doctors, dentists, plumbers, accountants, tax preparers, mortgage services, etc.). In some embodiments, the social media platform may provide opt-in and opt-out options, such as those depicted in FIG. 14. If the user has opted in to share, then the user engagement details may be shared, at block 1130, with one or more search engines, regardless of whether the user has previously used such search engines.

At block 1140, a detection may be made that the user has entered a search query, such as in the search engine for Google, Amazon, Google Maps, Yelp or another platform.

At block 1150, a determination may be made whether the search topic (or keywords) is related to the post from social media with which the user engaged either positively or negatively. If a determination is made that the search topic (or keywords) is related to the post from social media with which the user engaged either positively or negatively, then the process may move to block 1160, where a plurality of actions may be taken.

In some embodiments, the search engine or the marketplace platform, based on the search query at block 1140, may then return the results of the search at block 1160 and display both the search results and the social media post with which the user interacted.

In other embodiments, the search engine or the marketplace platform, based on the search query at block 1140, may then return the results of the search at block 1160 and rank the search results and display them in a ranking order based on user interest determined from the user engaging in a post on social media, e.g., a product, service, media asset, that the user positively engaged with on social media, if part of the search results may be displayed higher in order than other search results. Likewise, if the user positively engaged with a post on social media, and one or more attributes of the post are related to a first search result, from the plurality of search results, then the first search results may be shown by the search engine at a higher order than the remaining search results. For example, if the user is interested in a particular restaurant, vacation place, or object, as determined based on the user's positive engagement with the related post on social media, then such vacation place, restaurant, or object may be provided higher in the search results if it corresponds to the query entered at block 1140. If the search results were to include a specific restaurant, vacation please, or object, however a determination is made based on a negative engagement with the post in social media that the user dislikes that restaurant, then such a search result (e.g., vacation place, restaurant, or object) may be eliminated from being presented to the user or be presented much lower in the ranking order due to lack of interest determined.

In yet other embodiments, the search engine or the marketplace platform, based on the search query at block 1140, may then return the results of the search at block 1160 and also display recommendations, likes and dislikes of the user's contacts if they have engaged with a post that is related to the search query.

If a determination is made, at block 1150, that the search topic does not relate to the post from social media with which the user interacted, then, at block 1170, the search results may be displayed on their own without any references made to the social media post.

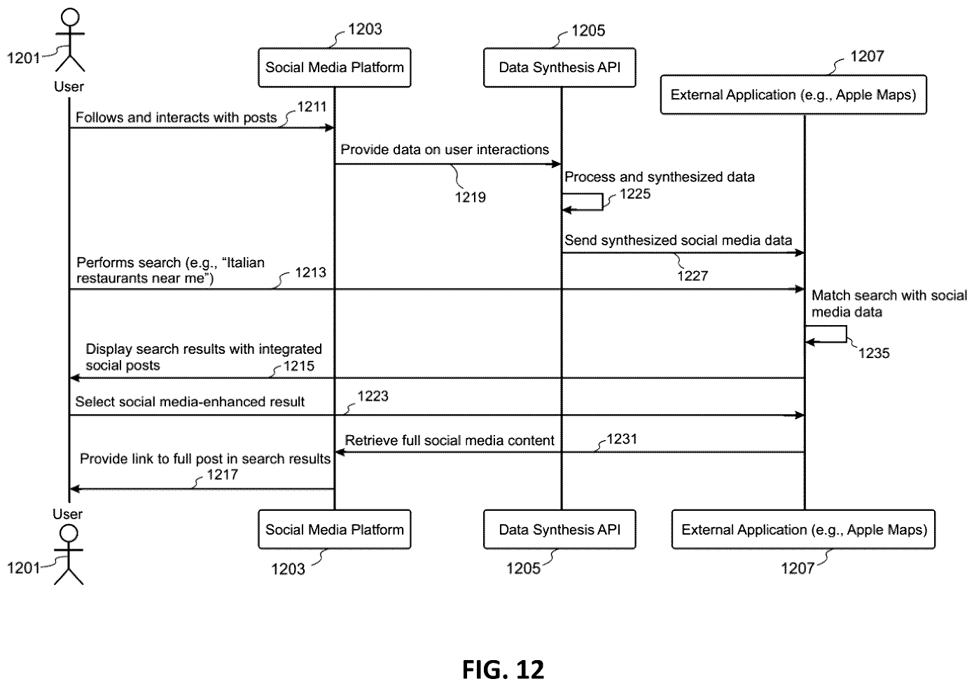

FIG. 12 is a flowchart of a process 1200 for enhancing search results for a query entered into a search engine based on user engagement with a post on a social media application, in accordance with some embodiments of the disclosure. Process 1200 is also used to describe communications between a social media platform and external applications for enhancing search results for a query entered into a search engine based on user engagement with a post on a social media application, in accordance with some embodiments of the disclosure. The process 1200 may be implemented, in whole or in part, by systems or devices such as those shown in FIGS. 2-3. One or more actions of the process 1200 may be incorporated into or combined with one or more actions of any other process or embodiments described herein. The process 1200 may be saved to a memory or storage (e.g., any one of those depicted in FIGS. 2-3) as one or more instructions or routines that may be executed by a corresponding device or system to implement the process 1200.

In some embodiments, the user 1201, at 1211, may follow, engage, and interact with a post on social media platform 1203. Some examples of type of engagement and interactions are depicted in FIG. 15 (e.g., engaging with the post by gazing at it, hovering over it, liking it, reposting it, commenting on it, etc.). Based on the user's interaction with the post, the social media platform 1203, at 1219, may provide data related to the interaction to the data synthesis API 1205. The data synthesis API 1205 may process and synthesize the data relating to the user's interaction at 1225. The data synthesis API 1205 may then make an API call and send the synthesized data, which is the social media data relating to the user's interaction with the post, to an external application 1207. An example of an external application may be a search engine such as Google, Yahoo, Bing, etc. In some embodiments, the synthesized data may be sent to the external application only if the user has preauthorized sending of such data.

In some embodiments, the external application 1207, such as Google, Yahoo, Bing or other search engine, or a marketplace search engine such as Amazon, or a map based search engine, such as Google or Apple maps, may receive a search at 1213 from the user 1201. In response to receiving the search, the external application (e.g., search engine) 1207, at 1235, may match the search query with the social media data received at 1227. The match may be based on the topic, category, genre of the search query. The match may also be based on keywords entered in the search query. The match may also be based on the content and context of the search query and its contextual match with the social media data.

If the external application 1207 determines a match between the entered search query and the social media data come on then at 1215, the external application may display search results with integrated social posts to the user.

In some embodiments, user 1201 may select a social media enhanced result option at 1223. When such a social media enhanced resolve option is selected, then the external application may provide to the user both search results related to the query as well as social media content (with which the user has interacted on the social media platform) that is matched with the query. To do so, in one embodiment, the external application may retrieve full social media content from the social media platform 1203 and display it to the user in response to the search query enter.

In another embodiment, the external application 1207 may provide the search results and the social media platform 1203 may provide the social media content related to the search query, i.e., posts with which the user has interacted, to the user. In this embodiment, the external application at 1230 one may notify the social media platform of the search query. The social media platform, based on the instructions provided by the external application, may match posts with which the user has interacted and display the posts, at 1217, to the user. In some embodiments, a link to the full post may be provided to the user and upon selection of the link the full post may be made available. Providing social media posts with which the user has interacted along with the search results may enhance the user's experience, such as by reminding the user of their previously expressed interest by engaging with the post on the social media application. By doing so, it may also increase the probability of the user selecting a search result, such as a restaurant, based on their previously indicated interest.

FIG. 13 is an example of enhanced search results based on user engagement with a post on a social media application, in accordance with some embodiments of the disclosure. In some embodiments, a user may engage with the social media post on a social media platform. As depicted at 1310, the user may have liked or selected a thumbs-up for a restaurant named Nobu displayed in the user's feed on the user's Facebook account.

At block 1310, the user's positive engagement, including the user ID; engagement metrics; details of the post, such as attributes of the post; metadata associated with the post; and the post and its images and clips may be shared by the social media server with a search engine such as Google 1330.

In some embodiments, the social media server may share the user ID; engagement metrics; details of the post, such as attributes of the post; metadata associated with the post and the post and its images and clips with only those search engines that have been authorized by the user. In other embodiments, the social media server may provide an opt-in/opt-out option and in those options list a plurality of search engines with whom the data may be shared. In yet another embodiment, the user may have linked their social media and search engine (e.g., Yelp, Google Maps, Apple Maps, Expedia, Kayak, Priceline, Amazon, Walmart, or search engines that find doctors, tax preparers, mortgage services, etc.) and such data may be shared with such linked search engines.

In some embodiments, the user using an electronic device may enter a search at 1320. As depicted in this example, the user may have searched for restaurants in Palo Alto at 1320.

At 1330, the search engine may receive the search query entered at 1320 as well as details of the social media engagement from block 1310. The search engine may then determine whether the search query matches the social media post from block 1310. In doing so, the search engine may compare keywords, phrases, context, and other attributes of the search query and the post from the social media platform. In this example, since the search query is for restaurants in Palo Alto, and the social media post relates to a restaurant, Nobu, which is also located in Palo Alto and positively engaged with by the user, the search engine may determine a match between the search query for the restaurant and the Nobu restaurant in the social media post.

At blocked 1340, the search engine may display search results for all the restaurants in Palo Alto and rank them based on the positive engagement at block 1310. In other words, among the restaurants in Palo Alto, since the user positively engaged with the Nobu restaurant in the social media post, Nobu restaurant may be ranked higher than other restaurants and displayed higher in the ranking order in the search results.

In some embodiments, the search engine may also display the social media post along with the search results. As depicted at 1350, the search engine may depict the Facebook post with which the user positively interacted such that the user is provided some context as to why the Nobu restaurant is being displayed higher in the search results.

Similarly, other products, locations, vacation places, and objects liked or positively engaged with by the user in social media maybe used by the search engines to factor in the user's preferences learned from social media engagement and accordingly rank search results in their applications. Some examples of such rankings may include displaying on maps the user's preferences learned from social media in a more visually distinguished manner than other objects on the map or displaying a product in the marketplace higher in the search results and highlighted when the other products aren't. Another example may be, upon a user entering a search for restaurants in the vicinity of their device, a) displaying only those restaurants on a map that the user engaged with via the social media posts, b) displaying the restaurants on a map that the user engaged with via the social media posts more prominently than other restaurants, and/or c) displaying links to the posts that the user engaged with next to restaurants that the used positively engaged with on social media.

FIG. 14 is an example of a communication process between a social media server and an OTT service provider server, in accordance with some embodiments of the disclosure. In this embodiment, the social media server may provide an opt-in and an opt-out option to the user for sharing data related to the user's engagement with the social media post with the OTT service provider server or a search engine. Some examples of opt-in options provided maybe to share all data associated with the user's engagement with the social media post, share the users account ID, share all engagement metrics associated with the users engagement with the post, or share selected engagement metrics. The user may be able to customize and select which data they authorize to be shared with the OTT service provider server or a search engine.

Some examples of opt out options provided may be for the user to opt out or place restrictions on sharing the user's account ID, engagement metrics associated with the post with which the user has engaged on social media, and any other opt-out customizations that the user may configure on the social media application.

Similar opt in and opt out provisions, in some embodiments, may also be implemented on the OTT server side, where the user may prevent the OTT service provider from sharing user consumption history with the social media server, search engine, or any other external application using user consumption history to select and post images or clips on the user's social media account.

In some embodiments, if a user opts in to share their information, the social media server may send the account ID, engagement metrics, and other details, at 1410 in FIG. 14, to the OTT service provider. The OTT service provider may receive the information is shared, at 1410, and then process the account ID, post ID, and engagement metrics at 1420. The processing may include analyzing the received information and associating the post ID with an action to be taken by the OTT service provider and using the account ID to identify the user associated with the OTT application.

In some embodiments, based on analyzing and associating with the user the engagement with the post on the social media server, the OTT service provider may take an action on the OTT application, which includes configuring a wallpaper or screen saver, or recommending media assets based on the preferences learned from the user's engagement with the post. Examples of receiving information related to the user's engagement with the post and accordingly personalizing and configuring the OTT application for the same user's account are described in FIGS. 8 and 9.

In another embodiment, such as described in FIGS. 4 and 6, at block 1430, the OTT service provider server may access and analyze the user's consumption history as it relates to the user's consumption of media assets using their account on the OTT application. Based on user preferences determined from analyzing the user's consumption history, the OTT service provider may then select images and clips from a media asset that are to be posted on a user's account on a social media application. The OTT service provider server may then provide the images and or clips along with instructions to the social media server for posting them on the user's account associated with the social media application. The social media server at 1440 may receive the images and or clips along with the instructions and accordingly post them on the user's account associated with the social media application. In some embodiments, the social media server may post the images and clips on a page associated with the OTT service provider such that those images and clips are targeted and visible for the user based on their user account. One example of implementation of blocks 1430 and 1440 is depicted in FIG. 6.

FIG. 15 is a block diagram of a plurality of engagement measuring factors used in determining the user's engagement with a social media post, in accordance with some embodiments of the disclosure. In some embodiments, the engagement measuring factors, also referred to herein as engagement metrics, may include select/click 1510, activate button 1520, hover 1530, gaze 1540, like/dislike 1550, repost/re-tweet 1560, interact with post for a duration 1570, comment 1575, share outside of social media 1580 (such as other social media platforms, messaging applications, emails, etc.), and skipped post 1585. Although a few examples of engagement measuring factors are described, the embodiments are not so limited, and other engagement measuring factors may also be used.

In some embodiments, an engagement measuring factor, from the plurality of engagement measuring factors, include measuring engagement related to a select/click 1510 performed by a user using their user interface. In this embodiment, a user may select or click on the social media post using their computer mouse, their finger on a touchscreen user interface, or their cursor using another type of device. For example, if the social media post includes a video and a user selects and clicks on the video to watch the video, then such an engagement may be determined as positive engagement. Likewise, if a user selects or clicks on a social media post to expand the text for reading, or expand an image associated with the post, or any other such action by selecting and clicking the post, then such engagement may also be determined as positive engagement.

In some embodiments, an engagement measuring factor, from the plurality of engagement measuring factors, include measuring engagement related to a pressing of an activate button 1520 that may be presented with a post on the social media platform. In this embodiment, the user may select an activation button provided by the social media application, which may be based on a request from the OTT service provider. In some embodiments, the OTT service provider may, via the social media application, provide a wallpaper or screen saver installation option when the user selects the post. If the user selects such a button or option, which may also be presented once the user selects the post, then such an engagement may be determined as positive engagement. In some embodiments, if the user selects a post and, upon selection, a wallpaper configuration option is provided to the user, but the user does not then select the wallpaper configuration option, then such an action may be associated with a negative action or may be associated with the user not wishing to install the presented wallpaper on their OTT application.

In some embodiments, an engagement measuring factor, from the plurality of engagement measuring factors, include measuring engagement related to a hovering action 1530 performed by a user using their user interface. In this embodiment, the user may simply hover over the post using their finger, cursor, computer mouse, etc., and not necessarily select or click the post as described in 1510. Such hovering over the post may also be taken as a positive engagement by the user.

In some embodiments, an engagement measuring factor, from the plurality of engagement measuring factors, include measuring engagement related to a gaze 1540 of the user directed at a post in the social media application. In this embodiment, the user may gaze at the social media post for a certain duration of time, and such gazing may be associated with a positive engagement by the user. In some embodiments, the electronic device on which the user is actively engaged with their social media application may include a camera facing the user. The camera may monitor the user's gaze and eyeball movement to determine whether the user is looking at a particular post. If a detection is made by the camera that the user is looking at a particular post based on the angle of their eyesight (e.g., line of sight), then such a gaze may be associated with a positive engagement by the user, e.g., indicating that the user may have an interest in the post. Likewise, if the OTT application causes, via the social media application, posting of a particular post, and a determination is made based on the camera input that the user is gazing at another post that is in the neighborhood of the post provided by the OTT application, but not at the post provided by the OTT application, then a determination may be made that the user is negatively engaged, or not interested in, the post made by the OTT application. As described previously, the post may be made by the OTT provider or by someone else.

In some embodiments, an engagement measuring factor, from the plurality of engagement measuring factors, include measuring engagement related to a like/dislike 1550 action performed by a user using their user interface. In this embodiment, the user may engage with the social media post by either liking or disliking the post. In some embodiments, the social media post may include a like or dislike icon, such as a thumbs-up or a thumbs-down icon, or some other form or like or dislike icon or button. Based on whether the user chooses and associated icon or button, a determination may be made whether the user is positively or negatively engaged with the social media post.

In some embodiments, an engagement measuring factor, from the plurality of engagement measuring factors, include measuring engagement related to a repost or re-tweet 1560 action performed by a user using their user interface. In this embodiment, if a user reposts or retweets a post that the user has viewed on their social media application, then such repost or retweet may be associated with a positive engagement. In some embodiments, the reposting and retweeting comments may also be considered in determining whether the engagement was a positive or a negative engagement or exceeds a threshold score. For example, if the user reposts a post that they have viewed on social media, such as a post made by the OTT service provider, and while reposting indicates in the comments that they did not like the post or makes some other negative comment about the post, then, although the user has reposted the post, the negative comment may be taken into consideration and the overall post, regardless of it being reposted, may be associated with a negative engagement.

In some embodiments, an engagement measuring factor, from the plurality of engagement measuring factors, include measuring engagement related to the user interacting with the post for a duration 1570 using their user interface. In this embodiment, if the user interacts with the post for a certain duration of time, e.g., their interaction exceeds a predetermined threshold of time, then the interaction may be considered as a positive engagement. On the other hand, if the user interacts with the post in less than the predetermined threshold of time, or the user skips the post, as indicated at 1585, then such interaction may be associated with a negative engagement.

In some embodiments, an engagement measuring factor, from the plurality of engagement measuring factors, include measuring engagement related to a comment 1575 made by a user using their user interface. In this embodiment, the comment made by the user, such as in the comments section of the post, may be analyzed to determine whether the engagement with the post is a positive or negative engagement or exceeds a threshold score. As such, using artificial intelligence algorithms, including leveraging LLM's, maybe used to input the comment made by the user associated with the post. The comment may be analyzed to determine whether it is a positive or a negative comment. The determination may be made based on the results of the analysis of the comment. In yet other embodiments, a further review of the comment may be made, such as, whether a threshold number of the user's contacts or others on social media have liked their comment. If a threshold number of other users liked the user's comment, then the user's comment may receive a higher weight, which can be either a positive or negative weight, based on the user's comment on the post. For example, if a user engages with a post associated with the certain movie and dislikes the post or makes a negative comment, and several social media users agree with the user's comments, then the user's negative engagement with the post will receive a higher weight.

In some embodiments, an engagement measuring factor, from the plurality of engagement measuring factors, include measuring engagement related to sharing of the post outside social media 1580 by the user using their user interface. In this embodiment, the user may have shared the post on other media, such as their e-mail, text messaging, or other communication applications. When a determination is made that the user has shared the post outside of social media, then such as sharing may be associated with a positive engagement by the user with the post.

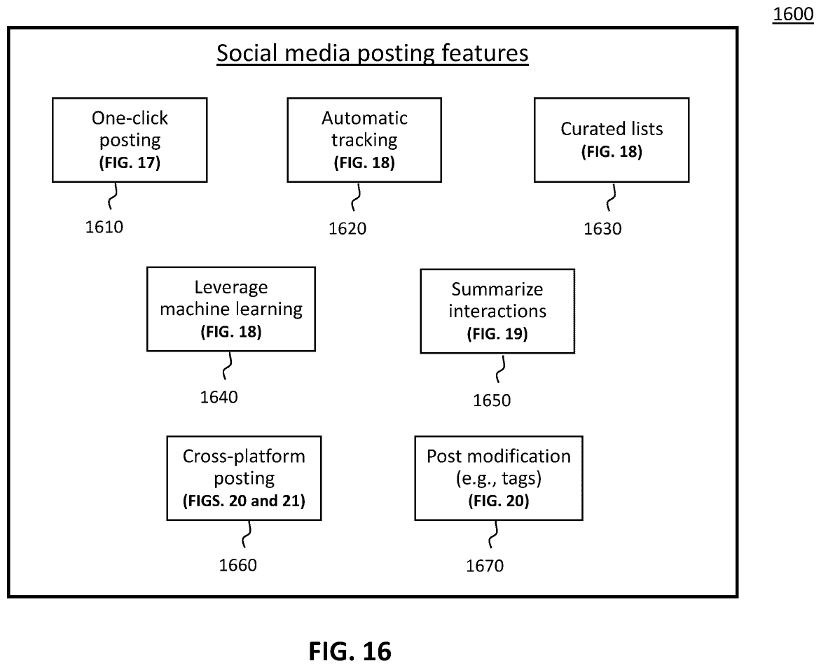

FIGS. 16-21 describe embodiments relating to a user posting efficiently on one or more social media platforms and managing their social media interactions. More specifically, the figures relate to managing and enhancing user interaction with content on social media platforms, generating summaries and curated lists of posts with which a user has interacted, leveraging machine learning to select posts with which the user has interacted based on user interest patterns, posting on multiple social media platforms by selecting the post's most appropriate and suitable platform based on its content, generating and customizing hashtags and captions for the post, and efficiently posting using a one-click feature.

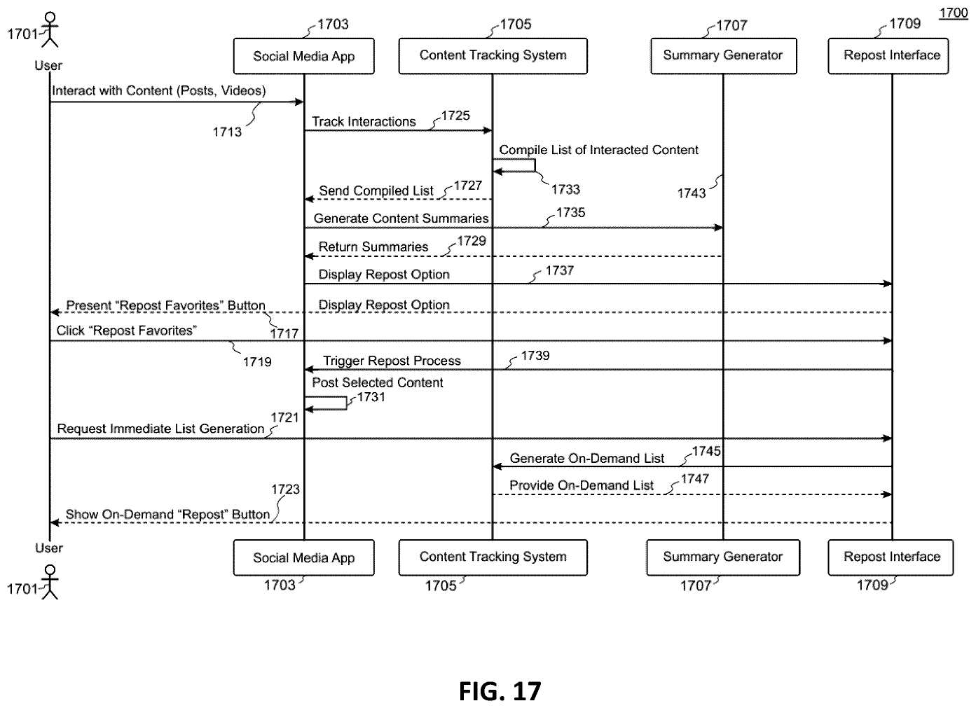

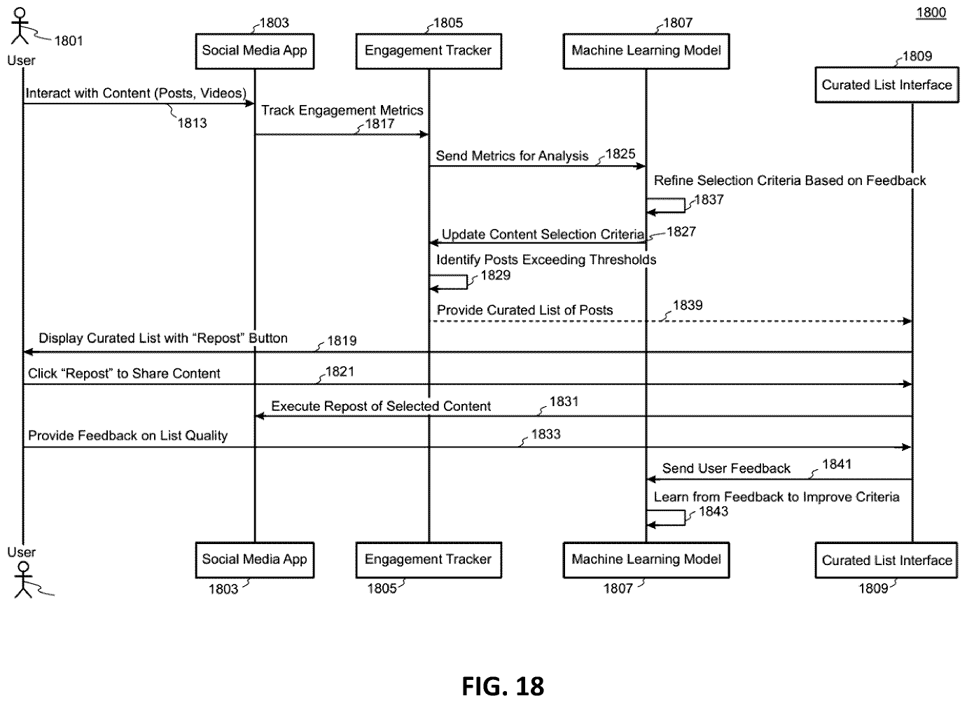

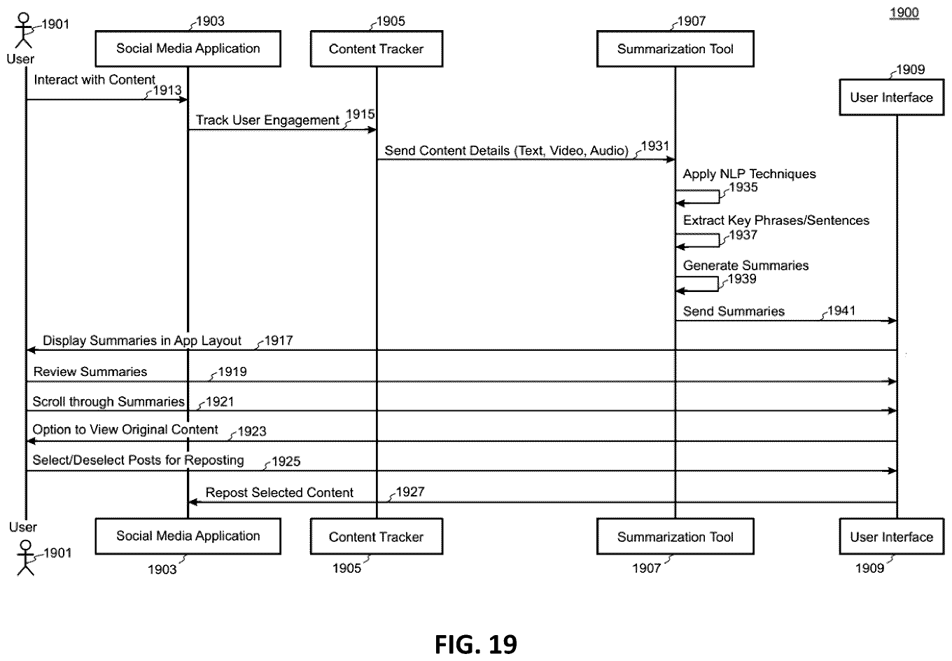

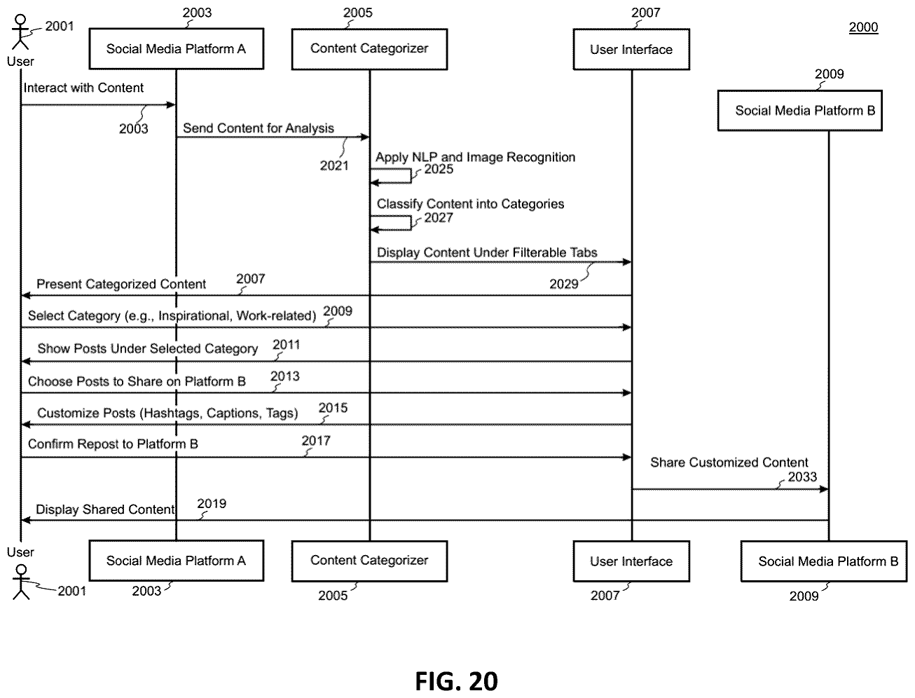

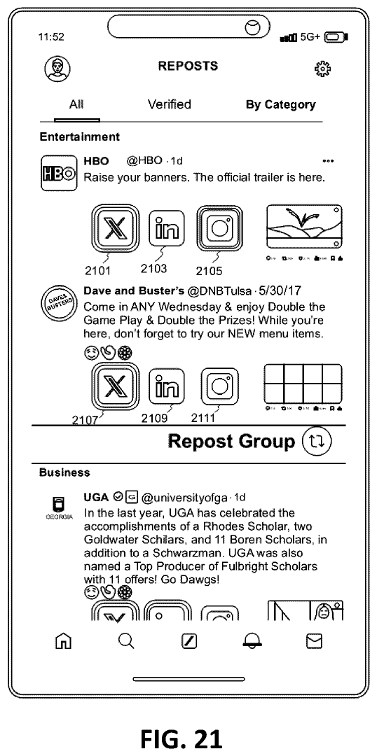

The embodiments of FIGS. 16-21 include, in some embodiments, a one-click feature, as described in FIG. 17. The one-click feature is provided for the user to post a single or multiple posts to multiple users and platforms. In some embodiments, this post or posts are in reaction to social media postings that the user interacted with on a social media application and with which the interaction and engagement was a positive engagement. Prior to posting, posts interacted with are curated, as described in FIG. 18, and summarized, as described in FIG. 19. The curated and summarized list of posts, in one embodiment, is then posted on a single social media platform using the one-click feature as described in FIG. 17 or in another embodiment, as described in FIGS. 20 and 21, posted on different platforms depending on their content, appropriateness, and suitability for a specific platform that supports such content. These and additional embodiments, as described in further detail below in FIG. 16, are provided to a user or enabled on the system associated with the social media platform, allow enhanced management and user interaction with content on social media platforms.

FIG. 16 is a block diagram of social media posting features provided by the methods and systems disclosed, in accordance with some embodiments of the disclosure. In some embodiments, the features include one-click posting 1610, automatic tracking 1620, curating lists 1630, leveraging machine learning 1640, summarizing interactions 1650, cross-platform posting 1660, and post modification 1670.

In one embodiment, one-click posting 1610 is provided to users on their user interface when the user is logged in to their account on the social media application. One-click posting allows the user to share content the user has previously interacted with. This feature automatically compiles and summarizes interactions such as posts users have viewed, such as posts viewed once, more than once, or extensively. It also automatically compiles and summarizes social media posts that were pinned, liked, commented, or previously reposted by the user, facilitating a quick review before reposting.

In some embodiments, the control circuitry 200 and/or 228 of a system, such as the system described in FIG. 2, which may be a social media system, performs automated tracking to monitor and record user interactions across various content types. The control circuitry 200 and/or 228 tracks engagement metrics, such as the duration of video views, to determine if the engagement surpasses a predefined threshold of interest. The control circuitry 200 and/or 228 also tracks other engagement metrics and associated measuring factors described in FIG. 15 to determine if the engagement is a positive or a negative engagement. This data related to the engagement metrics is used by the system to identify and store user preferences, thereby tailoring the repost suggestions more accurately. For example, if a user typically likes comedy-related posts and clicks on them, then such engagement metric may be identified and stored to suggest reposts that relate to comedy. In some embodiments, the one-click posting feature may be presented to the user with the option to repost their favorite posts, which are curated and summarized through a simple interface that includes a single button, such as a repost button. Additional details relating to the use of one-click posting, which may be offered as a repost button, are described in the discussion of FIG. 17.

In some embodiments, automatic tracking 1620 of the user's interactions and engagement with social media posts is performed. Keeping track of user interactions with posts includes posts interacted with in a current session as well as past sessions. Rather than a user having to scroll back in time to find a post with which the user interacted, automatic tracking provides easy search capabilities to search within current or previous sessions for a post that may have been of interest to the user. Such automatic tracking is performed across various content types-such as posts the user have reposted, pinned, liked, or commented on. Automatic tracking may also be performed across posts with which the user engaged with once, multiple times, or for significant durations, particularly by quantifying video engagement if the viewing time surpasses a predefined percentage of the video's total length. All posts identified during automatic tracking may be listed and made available for reposting with a single button click to repost favorites from that session.

Although some tracking methods have been used previously, they fall short and do not provide fully tracking functionality. For example, some previous methods notify a user about reposts to increase user interaction yet lack a mechanism for monitoring user engagement within a session or previous sessions. They only determine whether a post has been reposted. In another example, selective notification is provided to a user based on likelihood of another user engaging with the post. Unlike previous methods that do not track a user's engagement with a post, the embodiments described herein relating to automatic tracking that captures user content interactions within a single session or multiple sessions offer a granular understanding of engagement with which to create the list of items to include in the “one click” repost. The automatic tracking not only tracks which posts the user has engaged with, but also tracks detailed engagement metrics, such as the metrics described in FIG. 15. Such detailed capture of metrics can be used to analyze the depth of user engagement with the post(s) and dynamically generate summaries for potential reposting. This automatic tracking not only simplifies the reposting process by allowing the user to visualize all the posts with which the user interacted but also generates dynamic content summaries based on user engagement, thus encouraging re-engagement and providing a personalized user experience. As such, in short, embodiments relating to automatic tracking provide a unique combination of engagement tracking, automated summarization, and personalized content curation to enable a reposting of multiple posts with a single button click. Additional details relating to automatic tracking and use of data (e.g., posts and engagement metrics) captured are described in the process of FIG. 18.

In some embodiments, the control circuitry 200 and/or 228 of a system, such as the system described in FIG. 2, may generate curated lists 1630 of the posts with which the user interacted. Users often seek to revisit moments that were significant or enjoyable, but existing platforms lack the capability to intelligently curate and resurface content based on past interactions in a meaningful way. This leads to a static user experience that does not evolve based on user behavior or preferences. To overcome some of these drawbacks, the control circuitry may curate and resurface content based on the user's past interactions such that the curated content may be placed into a list and used for multiple purposes.

The curation process, in some embodiments, includes collecting data associated with posts with which the user has positively engaged, whether in a current session or in a previous session. The control circuitry may then analyze the posts, including interactions such as likes, reposts and content consumption, to generate dynamic summaries of content that the user has shown significant interest in. These may include summaries of content that the user engaged with in a current session or in a previous session. These summaries, in some embodiments, may summarize a group of posts by topic or some other interest that the user has engaged with. The control circuitry may then curate the summaries based on engagement metrics, such as the engagement metrics described in FIG. 15.

The control circuitry may also curate the summaries based on user interest, patterns of interest, degree of interest in one topic over another, etc. In some embodiments, the summaries may be automatically curated and presented as memories or highlights, providing users with a look back at content that resonated well with them. In some embodiments, each summary may be linked to the original post or content allowing the user to view the original while reviewing the curated list. By performing curation and generating curated lists, the control circuitry may personalize the user experience and also encourages re-engagement with content. The curated content presented may then be made available for the user to edit or repost within one click.

In some embodiments, the control circuitry may provide a content selection function for selectively marking and presenting content to be included in a curated list of recently interacted posts. Posts or content that meets or exceeds certain thresholds of engagement metrics may be flagged by the control circuitry for potential inclusion in the list. Curation may also clean data such that irrelevant data, e.g., data not of interest to the user, from the posts is removed before being compiled in the curated list. This curated list may be made accessible to the user through a user interface within the social media application. The user interface for displaying the lists may include a one-click button for reposting the entirety or a sub-portion of the curated list of posts.

In some embodiments, additionally, the control circuitry may use machine learning, as depicted at block 1640, to refine its selection process over time, learning from user feedback on the displayed curated lists. For instance, if a user frequently interacts with posts related to specific topics or types of content, the system could prioritize similar content in future compilations of the curated lists.

There may be one or many curated lists created per session that may be categorized by topic, interest, trending topic related content, etc. Curated list may also be specific for posting on another user's feed. For example, if the curated list is being generated for Fred to post on Tom's feed, then Tom's interests may also be considered in curating content that may be of interest to both Fred and Tom and only a subset of the posts that relate to Tom's interest may be placed in the curated list. Additional details relating to generation and use of curated lists is described in the process of FIG. 18.

In some embodiments, the control circuitry 200 and/or 228 of a system, such as the system described in FIG. 2, may summarize the interaction of the user with the social media posts, as depicted at 1650. In this embodiment, the control circuitry 200 and/or 228 summarizes the posts that the user has engaged with to provide a quick overview of the content, thereby allowing the user to review its relevance and appropriateness before taking actions, such as reposting, re-tweeting, or marking to be included in the curated list. In some embodiments, without user input, the control circuitry 200 and/or 228 may automatically generate a summary at the end (or during) each session that may provide summary of all posts the user has interacted with during the session. The summaries may also be organized by topic of the posts. These summaries that are automatically generated may be a compilation of interactions such as posts users have viewed, pinned, previously reposted, or engaged with using any of the engagement factors of FIG. 15.

To generate the summaries, the control circuitry 200 and/or 228, in one embodiment, may utilize a summarization tool that generates concise summaries of content that the user has interacted with. This tool may use natural language processing (NLP) techniques to analyze the content of posts, videos, and other media that have been tracked as part of the user's engagement session. The summaries generated by the control circuitry 200 and/or 228 may capture the essence of the content succinctly, providing the user with quick insights into the themes and key points discussed in the posts. This may enable the user to rapidly review the batch of posts before reposting. The summarization tool may also process the text within posts or extract key phrases and sentences from video subtitles or audio transcriptions. The summarization tool may then compile these into a summary that highlights the main ideas or emotional resonances of the content. The summary or memory may be presented to the user in a manner that mimics the normal layout of the social media application or user interface, allowing the user to scroll through and de-select the posts before continuing. Each summary may be linked to the original post or content, allowing the user to view the original while reviewing the curated list.

In some embodiments, the content/posts interacted with by the user may be analyzed for the depth of user engagement to dynamically generate summaries for potential reposting. For example, summaries of posts that the user has viewed extensively, pinned, or previously reposted, may be highlighted. An artificial intelligence engine using deep learning may be used to create summaries of such posts to provide a more in-depth and thoughtful analysis of the posts and create a suggested post with deeper meaning based on results from applying deep learning.

The summaries, once completed, may be reposted by the user using a user interface. In some embodiments, the control circuitry 200 and/or 228 may determine, based on usage metrics, the most suitable time to prompt the user to repost the summary or its creation for better engagement with other users. For example, if Tom, a contact of the user, likes the topic of the summary, and Tom, based on usage data, usually comes online usually at 6:00 p.m., then the control circuitry 200 and/or 228 may suggest posting of the summary that include a topic of Tom's interest at 6:00 p.m.

In some embodiments, prior to posting the summary, such as in its entirety or an edited version of the summary, the control circuitry may curate the summaries and present the user with a curated list of content, as described at 1630. Additional details relating to generation and use of summaries are described in the process of FIG. 19.

In some embodiments, the control circuitry may provide a cross-platform posting feature, as depicted at 1660. In this embodiment, the control circuitry 200 and/or 228 incorporates a cross-platform reposting feature that allows users to share selected content from one social media platform to another platform. To allow for posting on other platforms, the control circuitry 200 and/or 228, in some embodiments, categorizes posts automatically based on their content type-such as political, inspirational, or work-related-before they are presented for reposting. This categorization helps ensure that the content shared is appropriate and tailored to the norms and audience of the target platform. For example, if the content is professional, work-related, or career-related, then the control circuitry 200 and/or 228 determines that LinkedIn, which is typically used for professional content, is the appropriate platform for such a posting. Accordingly, the control circuitry 200 and/or 228 tailors the posts for LinkedIn, which may be include reformatting, rephrasing, summarizing the post using a professional tone, etc.

In some embodiments, the control circuitry 200 and/or 228 utilizes natural language processing and image recognition technologies to analyze the content of each post and classify it accordingly. For example, posts containing specific keywords or hashtags related to politics might be categorized as “Political,” while those featuring motivational quotes or uplifting images could be classified as “Inspirational.” Once posts are categorized, the user may be presented with a user-friendly interface that displays these categories as filterable tabs. Users may be able to select a category and view all the posts that fall under it. In one embodiment, this setup may allow users to easily decide which posts are suitable for reposting on different social platforms, and, in another the embodiment, the control circuitry 200 and/or 228 may automatically determine a suitable social platform for reposting or provide it as a suggestion to the user for selection. For instance, a user might choose to share inspirational content on platforms like Facebook or Instagram, where personal and motivational posts are common, but opt to share work-related articles or technology news on LinkedIn, where professional content is more appropriate.

When posting on other platforms, the control circuitry 200 and/or 228, in some embodiments, may allow the users to customize how posts are displayed on the target platform, including adding or modifying hashtags, captions, or tags to better suit the context of the secondary platform or the user's followers.

In yet another embodiment, the control circuitry 200 and/or 228 may display a menu of options where the user may select for reposting and based on the options selected, the same post may be reformatted, rephrased, and summarized differently in tone and language based on the platform on which it is to be posted.

In another embodiment, the control circuitry 200 and/or 228 may transport the likes and dislikes from one platform to another such that viewers of the other platform can determine the reputation of the post. However, since the platforms may not allow such transporting of likes from another platform, the information may be represented in another format to indicate that the likes/dislikes are associated with the post on another platform. Additional details relating to cross-platform posting, including the process of cross-platform posting, are described in the process of FIG. 20, and one example of a cross-platform posting is depicted in FIG. 21.

In some embodiments, the control circuitry may provide post modification 1670 options to a user, such as for reposting or posting on a different platform (e.g., cross-platform posting described in block 1660). The post modification may include placing or modifying a tag associated with the post. Using post modification options, users looking to repost may mark or tag posts as they see fit with keywords that are meaningful to them or their organizations or systems allowing their systems to act when receiving a callback that a user has engaged with the post.

In this embodiment, tags or metadata may be added to a post that create actionable buttons (for example, adding polls to a social media post that already exists). For example, the OTT service provider (e.g., Netflix) may post about a new release of media content on the social media platform and mark it as a recommendation. For example, for Netflix the metadata tag “1359284” could relate to recommendation or “NETFLIXREC” or any other metadata that Netflix understands. In another post, the Netflix social media poster may create a post about a new Netflix feature, for example for a new “top ten row.” The poster may add a tag into the post that will be interpreted by the social media website or application as an activation button or when the user reposts a post, or likes a post, which may also be considered an activation. Additional details relating to post modification and tagging are described in the process of FIG. 20.

FIG. 17 is a flowchart of a process 1700 for summarizing posts and providing them for reposting using a one-click feature, in accordance with some embodiments of the disclosure. Process 1700 is also used to describe communications between social media application, content tracking system, summary generator, and repost interface to provide reposting functions to a user for reposting a social media post, in accordance with some embodiments of the disclosure. The process 1700 may be implemented, in whole or in part, by systems or devices such as those shown in FIGS. 2-3. One or more actions of the process 1700 may be incorporated into or combined with one or more actions of any other process or embodiments described herein. The process 1700 may be saved to a memory or storage (e.g., any one of those depicted in FIGS. 2-3) as one or more instructions or routines that may be executed by a corresponding device or system to implement the process 1700.

In some embodiments, process 1700 utilizes a social media app 1703, content tracking system 1705, summary generator 1707, and repost interface 1709. In some embodiments, user 1701 engages with content posted on social media app at step 1713. The engagement by the user may be by any of the engaging factors described in FIG. 15.

In some embodiments, at step 1725, the user's engagement with a plurality of posts is tracked by the content tracking system. At step 1733, the content tracking system 1705 then compiles a list of content with which the user interacted. At step 1727, the compiled list is then sent to the social media app from the content tracking system. At step 1735, the social media app 1703 generates content summaries and transmits them to the summary generator 1707. The summary generator 1705, at step 1729, then curates and returns the summaries to the social media app. In some embodiments, the returned summaries are a subset of curated content summaries provided by the social media app to the summary generator.

At step 1737, in some embodiments, the social media application 1703 displays a repost option to the user On the repost interface 1709. For example, the repost interface 1709, which is the user interface, may display to the user at step 1717 a repost favorites button that may be selected. If the repost favorite button is selected by the user 1701, then at step 1719, the repost interface is informed at step 1719 that the user has selected to repost favorites.

At step 1739, the repost interface 1709 may trigger a repost process add the social media application 1709. The process may include the social media app 1703 to post selected content at step 1731 on the social media app 1703.

In some embodiments, at step 1721, the user 1701 may request immediate list generation to the repost interface 1709. This list generation may include a list of all the posts that are included in the repost favorites that have been posted on the social media app 1703 at step 1731. In response to receiving the immediate list generation request by the user, the repost interface 1709 may request the content tracking system 1705 to generate of an on demand list at step 1745. In response, at step 1747, the repost interface 1709 may receive the on demand list from the content tracking system 1705. The repost interface 1709 may then display the on demand repost button to the user 1701 at step 1723. The selection of the on demand repost button may result in displaying the on demand list to the user.

FIG. 18 is a flowchart of a process 1800 for generating curated lists or posts that can be reposted, in accordance with some embodiments of the disclosure. Process 1800 is also used to describe communication between social media application, engagement tracker, machine learning model, and a curated list interface to generate a curated list of posts from social media for reposting, in accordance with some embodiments of the disclosure. The process 1800 may be implemented, in whole or in part, by systems or devices such as those shown in FIGS. 2-3. One or more actions of the process 1800 may be incorporated into or combined with one or more actions of any other process or embodiments described herein. The process 1800 may be saved to a memory or storage (e.g., any one of those depicted in FIGS. 2-3) as one or more instructions or routines that may be executed by a corresponding device or system to implement the process 1800.

In some embodiments, a user 1801, at step 1813 may engage with content on a social media application 1803. The engagement may be any one of engagement types described in FIG. 15 where the user engages with the post on the social media.

At step 1817, the social media application 1805 may track engagement metrics associated with the user's engagement. Some examples of engagement metrics are described in FIG. 15, which are essentially the metrics for each type of engagement also described in FIG. 15. For example, if a user engages by hovering over the post, as depicted at 1530, then the engagement metrics may be computed for the hovering, such as how long did the user hover over the post, did the user hover over the post multiple times, did the user leave the mouse, cursor, on the post after hovering over it, etc. All such metrics, in some embodiments, may be calculated and an engagement score may be provided for each metric calculated metric based on the type, nature, and degree of engagement. For example, if a user hovers over the post above a threshold amount of time or a threshold number of times, the score may be higher than a single instance of the user hovering over the post for less than the threshold amount of time.

The social media app 1803 may transmit the engagement metrics at step 1817 to an engagement tracker 1805. The engagement tracker 1805 may further transmit the engagement metrics for analysis at step 1825 to a machine learning model 1807.

The machine learning model 1807 may receive the metrics and analyze them to detect patterns. The machine learning model 1807 may use the results of the analysis and detection of any patterns to refine selection criteria at step 1837. For example, if the machine learning model 1807 detects a pattern of the user has engaging with content relating to a certain type of genre, e.g., comedy, then the refined selection would use a comedy image or video to present to the user.

The machine learning model 1807 may then update the content selection criteria and transmit it to the engagement tracker 1805. The engagement tracker 1805 in response to receiving the content selection criteria may identify posts that exceed the content selection threshold. For example, if the criteria are to select a comedy scene, the engagement tracker 1805 may evaluate all scenes in a movie based on their comedy content, or in some embodiments, a genre score that may be calculated for the scene, and a scene that exceeds the genre score may be selected. In this embodiment, a genre score for each scene may also be calculated and saved. For example, a scene may have multiple genres, e.g., comedy and action and a genre score may be calculated for its comedy content and for its action content. If a determination is made based on the users pattern that the user generally likes comedy, then the machine learning model may recommend a selection criterion of a comedy scene to be displayed to the user. As such, at step 1829, the engagement tracker may evaluate a scene for its comedy score and select A scene that exceeds a comedy score above it threshold provided by the machine learning model. In other embodiments, instead of a score, other criteria may be used to select a scene, image, or video that exceeds the selection criteria attached threshold.

The engagement agent tracker 1805, at step 1839, may provide a curated list of posts to the curated list interface 1809. The curated lists may be generated by collecting data associated with posts with which the user has positively engaged, analyzing the type, nature, and degree of engagement and based on the analysis generating dynamic summaries of content that the user has shown significant interest in and then curating the summaries based on engagement metrics, such as the engagement metrics described in FIG. 15, to include a subset of posts that meet the curation criteria in the curated list.

At step 1819, the curated list interface 1809 may transmit the curated list with a repost button to the user 1801. If the user selects by clicking on the repost button to share the content, then at step 1821, the curated list interface 1809 is informed of the users selection/click to repost. The curated list interface 1809 may then, at step 1831, execute repost of selected content on the social media app 1803. By doing so, the user may easily repost a curated post or group of posts on the social media application.

In some embodiments, the user 1801 may provide feedback on the list quality at step 1833. Such feedback may be transmitted to the curated list interface 1809. Upon receiving the feedback, the curated less interface 1809 may send the user feedback at step 1841 to the machine learning model 1807. The machine learning model 1807 may continue to learn from the feedback and improve the criteria at step 1843 for subsequent post and content selection criteria.

FIG. 19 is a flowchart of a process 1900 for generating summaries of posts that may be used for reposting, in accordance with some embodiments of the disclosure. Process 1900 is also used to describe communications between social media application, content tracker, summarization tool, and user interface for generating a summary of a social media post(s) with which a user has interacted, in accordance with some embodiments of the disclosure. The process 1900 may be implemented, in whole or in part, by systems or devices such as those shown in FIGS. 2-3. One or more actions of the process 1900 may be incorporated into or combined with one or more actions of any other process or embodiments described herein. The process 1900 may be saved to a memory or storage (e.g., any one of those depicted in FIGS. 2-3) as one or more instructions or routines that may be executed by a corresponding device or system to implement the process 1900.

In some embodiments, user 1901 may interact with content on the social media application 1903. Some examples of the type of interaction and engagement with content is described in the description related to FIG. 15. For example, one such type of engagement may be by the user commenting on a post displayed on the social media application connected to the user's account. Another example of interaction may include they user reposting or retweeting a post that the user has consumed on the social media application via their social media account.

At step 1915, the social media application 1903 may track engagement metrics associated with the user's engagement with content, such as posts on the social media application that the user has engaged with using their social media account and send the user engagement details to the content tracker 1905. Some examples of engagement metrics are described in FIG. 15, which are essentially the metrics for each type of engagement also described in FIG. 15. For example, if a user engages by hovering over the post, as depicted at 1530, then the engagement metrics may be computed for the hovering, such as how long did the user hover over the post, did the user hover over the post multiple times, did the user leave the mouse, cursor, on the post after hovering over it, etc. All such metrics, in some embodiments, may be calculated and an engagement score may be provided for each metric calculated metric based on the type, nature, and degree of engagement. For example, if a user hovers over the post above a threshold amount of time or a threshold number of times, the score may be higher than a onetime hovering of less than the threshold amount of time.

At step 1931, the content tracker 1905, in response to receiving details associated with the user engagement, may send content details, such as text video and audio details, at step 1931, to a summarization tool 1907.

The summarization tool 1907 may apply natural language processing (NLP) techniques at step 1935 and extract key phrases and sentences at step 1937 to generate summaries at step 1939. Summarization may include generating a concise summary that conceptually captures the post. The level of summarization, in some embodiments, may be automatically determined based on the user's level of proficiency that may also be automatically determined based on the user's use of language. For example, a machine learning tool may detect patterns of use by the user and determine the user's proficiency to then use then same level of proficiency for summarizing the posts. The user may also adjust the level of detail of the summarization from a lesser to more detailed level of summarization. The summarization of posts may be dynamic, personalized, and curated and made available for easy reposting using the single button click feature. The summaries may automatically be created for only those social media posts with which the user has interacted positively. It may also be for posts that the user has viewed, such as posts viewed once, more than once, or extensively. Summaries may also be generated automatically and compiled for social media posts that were pinned, liked, commented, or previously reposted by the user, facilitating a quick review before reposting. These summaries, in some embodiments, may summarize a group of posts by topic or some other interest that the user has engaged with.

At step 1941, the summarization tool 1907 may send the generated summaries to the user interface 1909. The user interface may then display the summaries in an application layout at step 1917 to the user 1901. The user 1901 may review the summaries at step 1919 on their user interface and perform actions such as scrolling through the summaries (1921) or viewing original content associated with the summaries (1923).

In some embodiments, the user 1901, at step 1925, may select or deselect posts from associated with the summaries for reposting. In this embodiment, the user's selection and/or deselection of posts from the provided summaries and the indication to repost may be received via the user interface 1909. The user interface 1909, may then repost the selected content (e.g., posts) at step 1927, such as via utilizing control circuitry of system of FIG. 2

FIG. 20 is a flowchart of a process 2000 for cross-posting posts on multiple platforms, in accordance with some embodiments of the disclosure. Process 2000 is also used to describe communications between multiple distinct social media platforms, content categorizer, and user interface for cross posting on multiple platforms, in accordance with some embodiments of the disclosure. The process 2000 may be implemented, in whole or in part, by systems or devices such as those shown in FIGS. 2-3. One or more actions of the process 2000 may be incorporated into or combined with one or more actions of any other process or embodiments described herein. The process 2000 may be saved to a memory or storage (e.g., any one of those depicted in FIGS. 2-3) as one or more instructions or routines that may be executed by a corresponding device or system to implement the process 2000.

In some embodiments, user 2001 may interact with content on the social media platform A 2003. Some examples of the type of interaction and engagement with content is described in the description related to FIG. 15.

At step 2021, the social media platform A 2003 may send the content, such as social media posts, for analysis to a content categorizer 2005.

At step 2025, the content categorizer 2005 may apply NLP and image recognition techniques to the received content. The content categorizer 2005 make classify content into a plurality of categories based on the NLP and image recognition analysis. For example, the content may be categorized based on its topic, genre, social, work-related, context, or some other type of categorization.

At step 2029, the content categorizer 2005 may display the categorized content under filterable tabs on a user interface 2007.

At step 2009, the user 2001 may select a category from the plurality of categories of content presented to the user. The user may make such a selection using their user interface 2007. Upon making the selection of a specific category, posts related to that category may be displayed to the user at step 2011 on the user interface. The user may then select posts associated with the category to share on a different platform, such as platform B, at step 2013. The user interface may then customize the posts, such as by adding hashtags, captions, or other type of tags at step 2015. Once the user confirms reposting with the customizations to platform B at step 2017, the posts may be reposted on platform B at step 2033 and the content displayed on platform B may be shared with the user 2011 at step 2019.

FIG. 21 is an example of a post being cross-posted on multiple social media platforms, in accordance with some embodiments of the disclosure. In some embodiments, cross-posting refers to posting posts from one social media platform to one or more other social media platforms. For example, a single post from Facebook with which the user has positively interacted maybe reposted by the user to multiple distinct platforms such as X (formerly twitter), LinkedIn, Instagram. In another embodiment, the user may have interacted with multiple posts on a social media application. The multiple posts may be summarized and presented to the user and the user may indicate an interest to repost the multiple posts to different platforms. Upon determining the user's intent to repost, the control circuitry may automatically determine which platform is most appropriate for each of the posts, in the plurality of posts, with which the user has positively interacted on at least one social media.

The cross platform posting feature may be enhanced by the system's ability to categorize posts automatically based on their content type-such as political, social, inspirational, or work-related-before they are presented for reposting. This categorization may ensure that content shared is appropriate and tailored to the norms and audience of the target platform, such as LinkedIn for work-related posts. The system may utilize natural language processing and image recognition technologies to analyze the content of each post and classify it accordingly. The system may automatically, without user input, may select (or suggested to user) social media platforms for reposting. In some embodiments, the control circuitry may provide a table for the users consumption that may indicate which posts have been reposted and to which platform. The table display, or similar format of display, may allow the user to keep a tab of all the reposts and visually be aware of all reposting activity performed for the user.

As depicted in FIG. 21, in some embodiments, an icon (or some other display representative of the social media platform), such as icons 2101, 2103, 2105, may be depicted on the user's interface indicating to which platforms the post has been reposted. For example, the Dave and Buster's promotion with which the user may have interacted may be reposted to X 2107, LinkedIn 2109, and Instagram 2111 platforms with which the user has an account.

It will be apparent to those of ordinary skill in the art that methods involved in the above-described embodiments may be embodied in a computer program product that includes a computer-usable and/or -readable medium. For example, such a computer-usable medium may consist of a read-only memory device, such as a CD-ROM disk or conventional ROM device, or a random-access memory, such as a hard drive device or a computer diskette, having a computer-readable program code stored thereon. It should also be understood that methods, techniques, and processes involved in the present disclosure may be executed using processing circuitry.

The processes discussed above are intended to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods. It should also be noted that the systems and/or methods described above may also apply to audio and video engagement by participants during the live streaming session and are not limited to chat messages.

What is claimed is:

1. A method comprising:
establishing a link between user accounts associated with a social media application and an external application for a first user;
detecting engagement with a social media posting associated with the social media application by the first user using their social media account, wherein the social media posting includes an image, scene, or a video having a plurality of attributes;
determining whether the engagement exceeds a predetermined positive or negative engagement threshold; and
in response to determining that the engagement exceeds the positive engagement threshold:
obtaining metadata associated with the engagement with the social media posting;
configuring display for the user account associated with the external application using the obtained metadata; and
displaying on a user interface for the user account associated with the external application, the display configured based on the obtained metadata.

2. The method of claim 1, wherein the external application in an OTT application.

3. The method of claim 2, wherein the engagement with the social media posting by the first user relates to the first user's selection of a screen saver or a wallpaper option for an image associated with the social media posting.

4. The method of claim 3, further comprising:
receiving the first user's selection of the screen saver or the wallpaper option, wherein the received selection includes a post ID associated with the social media posting and a user ID associated with the first user; and
in response to receiving the first user's selection, configuring the display for the user account associated with the external application comprises displaying the image associated with the social media posting as either a screen saver or a wallpaper, based on the received selection, on the first user's account associated with the OTT application.

5. The method of claim 2, wherein configuring display for the user account associated with the external application using the obtained metadata further comprises:
determining a genre preference by the first user based on the obtained metadata;
searching for one or more media assets offered via the OTT application that matches the determined genre preference; and
configuring the display for the user account associated with the external application comprises displaying the one or more media assets that match the determined genre preference as recommendations to the first user.

6. The method of claim 2, further comprising:
determining that the engagement with the social media posting exceeds the predetermined negative threshold; and
in response to determining that the engagement exceeds the predetermined negative threshold:
determining a genre of the social media posting associated with the engagement; and
configuring display for the user account associated with the OTT application such that a media asset that matches the genre of the social media posting associated with the engagement is not recommended to the first user on the first user's account associated with the OTT application.

7. The method of claim 1, further comprising:
receiving a search query inputted by the first user into the external application, wherein the external application is a search application that is separate from the social media application;
determining whether a topic of the search query is related to a topic of the social media posting with which the first user engaged; and
in response to determining that the topic of the search query is related to the topic of the social media posting with which the first user engaged, displaying on a user interface associated with the first user's account on the search application, a) search results responsive to the received search query and b) the social media posting with which the first user engaged.

8. The method of claim 7, wherein displaying the search results on the user interface associated with the first user's account on the search application further comprises:
receiving the search results in response to performing a search using a search engine associated with the search application;
ranking the search results based on obtained metadata; and
displaying the search results in an order associated with the ranking.

9. The method of claim 1, further comprising:
receiving a search query inputted by the first user into the external application, wherein the external application is a search application that is separate from the social media application;
determining whether a topic of the search query is related to a topic of the social media posting with which the first user engaged; and
in response to determining that a) the topic of the search query is related to the topic of the social media posting with which the first user engaged and b) that the engagement with the social media posting by the first user exceed the negative threshold:
eliminating a search result, from the search results responsive to the received search query, whose topic relates to the topic of the second social media posting.

10. The method of claim 1, wherein the engagement detected with the social media posting is any one of selecting the social media posting, hovering over the social media posting, commenting on the social media posting, reposting the social media posting, retweeting the social media posting, liking or disliking the social media posting, gazing at the social media posting for a predetermined duration of time, or skipping over the social media posting.

11. A system comprising:
communications circuitry configured to access a social media application; and
control circuitry configured to:
establish a link between user accounts associated with the social media application and an external application for a first user;
detect engagement with a social media posting associated with the social media application by the first user using their social media account, wherein the social media posting includes an image, scene, or a video having a plurality of attributes;
determine whether the engagement exceeds a predetermined positive or negative engagement threshold; and
in response to determining that the engagement exceeds the positive engagement threshold:
obtain metadata associated with the engagement with the social media posting;
configure display for the user account associated with the external application using the obtained metadata; and
display on a user interface for the user account associated with the external application, the display configured based on the obtained metadata.

12. The system of claim 11, wherein the external application in an OTT application.

13. The system of claim 12, wherein the engagement with the social media posting by the first user relates to the first user's selection of a screen saver or a wallpaper option for an image associated with the social media posting.

14. The system of claim 13, further comprising, the control circuitry configured to:
receive the first user's selection of the screen saver or the wallpaper option, wherein the received selection includes a post ID associated with the social media posting and a user ID associated with the first user; and
in response to receiving the first user's selection, configure the display for the user account associated with the external application comprises displaying the image associated with the social media posting as either a screen saver or a wallpaper, based on the received selection, on the first user's account associated with the OTT application.

15. The system of claim 12, wherein configuring display for the user account associated with the external application using the obtained metadata further comprises, the control circuitry configured to:
determine a genre preference by the first user based on the obtained metadata;
search for one or more media assets offered via the OTT application that matches the determined genre preference; and
configure the display for the user account associated with the external application comprises displaying the one or more media assets that match the determined genre preference as recommendations to the first user.

16. The system of claim 12, further comprising, the control circuitry configured to:
determine that the engagement with the social media posting exceeds the predetermined negative threshold; and
in response to determining that the engagement exceeds the predetermined negative threshold:
determine a genre of the social media posting associated with the engagement; and
configure display for the user account associated with the OTT application such that a media asset that matches the genre of the social media posting associated with the engagement is not recommended to the first user on the first user's account associated with the OTT application.

17. The system of claim 11, further comprising, the control circuitry configured to:
receive a search query inputted by the first user into the external application, wherein the external application is a search application that is separate from the social media application;
determine whether a topic of the search query is related to a topic of the social media posting with which the first user engaged; and
in response to determining that the topic of the search query is related to the topic of the social media posting with which the first user engaged, display on a user interface associated with the first user's account on the search application, a) search results responsive to the received search query and b) the social media posting with which the first user engaged.

18. The system of claim 17, wherein displaying the search results on the user interface associated with the first user's account on the search application further comprises, the control circuitry configured to:
receive the search results in response to performing a search using a search engine associated with the search application;
rank the search results based on obtained metadata; and
display the search results in an order associated with the ranking.

19. The system of claim 11, further comprising, the control circuitry configured to:
receive a search query inputted by the first user into the external application, wherein the external application is a search application that is separate from the social media application;
determine whether a topic of the search query is related to a topic of the social media posting with which the first user engaged; and
in response to determining that a) the topic of the search query is related to the topic of the social media posting with which the first user engaged and b) that the engagement with the social media posting by the first user exceed the negative threshold:
eliminate a search result, from the search results responsive to the received search query, whose topic relates to the topic of the second social media posting.

20. The system of claim 11, wherein the engagement detected by the control circuitry with the social media posting is any one of selecting the social media posting, hovering over the social media posting, commenting on the social media posting, reposting the social media posting, retweeting the social media posting, liking or disliking the social media posting, gazing at the social media posting for a predetermined duration of time, or skipping over the social media posting.
